(19) United States
(12) Patent Application Publication
(10) Pub. No.: US 2023/0218979 A1
(43) Pub. Date: Jul. 13, 2023

(54) CARD PROTECTIVE APPARATUS

(71) Applicant: Rare Edition, Inc., Beverly Hills, CA (US)

(72) Inventors: Robert Lee, Beverly Hills, CA (US); Tiancheng Zhu, Mountain View, CA (US)

(73) Assignee: Rare Edition, Inc., Beverly Hills, CA (US)

(21) Appl. No.: 17/811,052

(22) Filed: Jul. 6, 2022

Related U.S. Application Data
(60) Provisional application No. 63/226,139, filed on Jul. 27, 2021.

(51) Int. Cl. A63F 1/06; A45C 11/18; B23K 20/10

(52) U.S. Cl. CPC A63F 1/062; A45C 11/18; B23K 20/10

(57) ABSTRACT

A protective apparatus comprising a first panel, a rear panel, and a mask, the first panel including a front side and a back side, the first panel including at least a transparent portion, the rear panel being coupled to the first panel, the front side of the rear panel including at least four supporting members, each of the at least four supporting members including a flat edge to enable positioning of a collectible object, the cavity being at least between the flat edges of the four supporting members, and the mask coupled to the back side of the first panel, the mask being opaque and extending around a perimeter of the back side of the first panel, the mask covering an inside of the protective apparatus between the first panel and the second panel.

### CROSS-REFERENCE TO RELATED APPLICATIONS

The present application claims the benefit of U.S. Provisional Patent Application No. 63/266,139 filed Jul. 27, 2021, entitled “PROTECTOR APPARATUS,” which is incorporated by reference herein.

### FIELD OF THE INVENTIONS

Embodiments described herein generally relate to a protective apparatus that may be used to protect one or more trading cards, game cards, sports cards, collectible cards, autographs, letters, coins, stamps, and the like.

### BACKGROUND

Collectible cards such as trading cards, sports cards, game cards, or collectible cards may include a card depicting information and/or an image of a person, place, thing, and/or concept. Cards as described herein typically comprise paper, cardboard, and/or similar materials. A card as discussed herein may be related to sports (e.g., baseball cards), a game, or the like. In some examples, a card may depict and/or describe non-fiction people, nonfictional or fictional animals, fictional people or animals, spells, nonfictional or fictional places, actions, nonfictional or fictional items, and/or the like.

Collectible cards may be graded based on physical condition. A higher grade means that the card is more desirable and, correspondingly, worth more money. There are secondary markets for many cards whereby collectors may seek rare and/or desirable cards in good condition for purchase.

The value of a card, whether they are graded or not, may be protected with the use of a card protector. The card protector may protect the card from dust, oil, accidental bending, and scratches.

### SUMMARY

An example protective apparatus comprises a first panel, a second panel, and a mask. The first panel includes a front side and a back side, the first panel including at least a transparent portion. The rear panel is coupled to the first panel. The rear panel including a front side and a back side. The front side of the rear panel includes at least four supporting members, each of the at least four supporting members including a flat edge to enable positioning of a collectible object. The flat edge of a first two of the supporting members being parallel to each other. The flat edge of a second two of the supporting members being parallel to each other and perpendicular to the first two of the supporting members. The protective apparatus including a cavity being at least between the flat edges of the four supporting members, the cavity capable of holding the collectible object. The protective apparatus including a mask coupled to the back side of the first panel, the mask being opaque and extending around a perimeter of the back side of the first panel, the mask covering an inside of the protective apparatus between the first panel and the second panel.

In various embodiments, the first panel and the second panel comprises polycarbonate, the polycarbonate protecting the protective apparatus and/or the collectible object contained within the protective apparatus from impacts and ultraviolet light. The protective apparatus may include an identifier (e.g., logo or mark) that is hot stamped on the polycarbonate. The identifier may assist in identifying the card, the make of the protective apparatus, and/or provide an indication of authenticity.

The protective apparatus may include a bumper made of a resilient material that surrounds edges of the first panel and the second panel. In some embodiments, the protective apparatus includes at least one security feature between the first panel and the second panel. The security feature may be an NFC chip or an RFID chip. The security feature may be beneath the mask such that the security feature is not visible from the front of the first panel.

In various embodiments, the protective apparatus includes an elevated edge along the edge of the first panel or the second panel. The elevated edge may extend between the first panel and the second panel. The elevated edge prevents debris from entering the protective apparatus. The elevated edge may be laser welded to the first panel or the second panel to couple the two panels together and/or prevent tampering with the collectible object. Laser welding the elevated edge may prevent water from entering the protective apparatus is submerged.

The protective apparatus may include a protective layer adhered to the front side of the first panel. The protective layer may be transparent and configured to prevent damage to the front side of the first panel. In one example, the protective layer is Gorilla Glass or a similar material. The mask may define a first window and a second window of the first panel. The second window may be rectangular and the size of a collectible card (e.g., sports card). The second window may be at least a portion of the cavity to enable viewing of the collectible object. The first window may be shorter than the first window and may contain information.

In some embodiments, the rear panel or the front panel includes a perimeter member at the perimeter of the rear panel or the front panel. The perimeter member may be configured to engage with the elevated edge to couple the first panel and the second panel together to reduce opportunities for tampering with the collectible object. The elevated edge may be laser welded to the perimeter member, thereby improving tamper resistance of the protective apparatus, reducing the opportunity for tampering with the collectible card, and reducing the opportunity to tamper with security features.

An example method for fabricating a protective apparatus may comprise fabricating a first panel, the first panel including a front side and a back side, the first panel including at least a transparent portion, fabricating a rear panel, the rear panel including a front side and a back side, the front side of the rear panel including at least four supporting members, each of the at least four supporting members including a flat edge to enable positioning of a collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object, coupling a mask to the back side of the first panel, the mask being opaque and extending around a perimeter of the back side of the first panel, the mask covering an inside of the protective apparatus between the first panel and the second panel, and coupling the first panel and the second panel.

The first panel and the second panel may be made of polycarbonate thereby protecting the collectible object from impacts on the protective apparatus or ultraviolet light.

The method may further comprise coupling a bumper made of a resilient material around edges of the first panel and the second panel. In some embodiments, the method further comprises adding a security feature between the first panel and the second panel before the first panel is coupled to the second panel. The security feature may include at least one of an NFC chip and an RFID chip. The security feature may be beneath the mask such that the security feature is not visible from the front of the first panel.

The protective apparatus may further comprise an elevated edge along the edge of the first panel or the second panel. The elevated edge may extend between the first panel and the second panel, the elevated edge preventing debris from entering the protective apparatus. Coupling the first panel and the second panel may comprise laser welding an elevated edge to couple the first panel and the second panel. In some embodiments, laser welding of the elevated edge prevents water from entering between the first panel and the second panel if the protective apparatus is submerged.

In various embodiments, the method further comprises coupling a protective layer to the front side of the first panel, the protective layer being transparent and configured to prevent damage to the front side of the first panel.

### BRIEF DESCRIPTION OF THE DRAWINGS

FIG. 1A depicts a frontal view of a protective apparatus in some embodiments.

FIG. 1B depicts a perspective view of a protective apparatus in some embodiments.

FIG. 1C depicts another perspective view of a protective apparatus in some embodiments.

FIG. 1D depicts another frontal view of a protective apparatus in some embodiments.

FIG. 2A depicts one example side of a back panel that makes up the protective apparatus in some embodiments.

FIG. 2B depicts another example side of the back panel, which makes up the protective apparatus in some embodiments.

FIG. 3A depicts one example side of a front panel that makes up the protective apparatus in some embodiments.

FIG. 3B depicts another example side of the front panel, which makes up the protective apparatus in some embodiments.

FIG. 4 depicts a perspective view of a bumper in some embodiments.

FIG. 5A depicts a front view of a protective apparatus with a bumper in some embodiments.

FIG. 5B depicts one perspective view of a protective apparatus with a bumper in some embodiments.

FIG. 5C depicts another perspective view of a protective apparatus with a bumper in some embodiments.

FIG. 6A depicts an example front view of the protective apparatus with a bumper in some embodiments.

FIG. 6B depicts an example back view of the protective apparatus with a bumper in some embodiments.

FIG. 6C depicts various example views of the protective apparatus in some embodiments.

FIG. 6D depicts perspective views of the protective apparatus with a bumper in some embodiments.

FIG. 7A depicts an example front view and cross-sections of the back panel in some embodiments.

FIG. 7B depicts an example front view and cross-sections of the back panel with measurements.

FIG. 7C depicts an example logo in some embodiments.

FIG. 8A depicts an example back view and cross-sections of the protective apparatus in some embodiments.

FIG. 8B depicts an example energy director for ultrasonic welding in some embodiments.

FIG. 9 depicts an example cross-section of a back panel and a front panel of the protective apparatus in some embodiments.

FIG. 10 depicts an example block diagram of an example environment capable of grading cards providing grading records associated with the cards in some embodiments.

FIG. 11 depicts an example collectible card interface containing information regarding a card in some embodiments.

FIG. 12 depicts an example marketplace interface in some embodiments.

FIG. 13 is an example of a digital device in some embodiments.

### DETAILED DESCRIPTION

A protective apparatus may protect valuable collectible cards (e.g., trading cards, sports cards, game cards, and/or the like). The protective apparatus discussed herein is described as being configured to hold a card (e.g., the protective apparatus may be a card protector). However, it will be appreciated that similar protective apparatuses (e.g., of many different sizes) may protect other items such as stamps, autographs, paper, coins, pamphlets, and the like. It will be appreciated that any valuable item (or two or more valuable items) may be stored within the protective apparatus described herein. Some embodiments allow for a UV-resistant, tamper-resistant case to protect the enclosed item from damage that may affect the value of the enclosed item.

In some embodiments, the protective apparatus (e.g., card case) also includes a removable bumper surrounding the edges of the protective apparatus. The bumper may protect the card encased within the protective apparatus as well as protect the protective apparatus itself.

While a bumper is shown surrounding the edges of the protective apparatus, it will be appreciated that the bumper may enclose all or a back portion of the protective apparatus. In some embodiments, the bumper may be similar to a smartphone case that encloses the edges of a smartphone or encloses the edges and the back of the smartphone. In some embodiments, the bumper may protect the back part of the device or a portion of the back part of the protective apparatus. In one example, the bumper may surround the edges of the protective apparatus as well as a part of the back of the protective apparatus. In this example, the bumper may include an opening or window to allow parts of the enclosed card or protective apparatus to be seen from behind (e.g., information on the back of the card and/or protective apparatus may be seen through a hole or window in the back bumper).

It will be appreciated that the bumper may be composed of one or more different materials. The one or more different materials may be resilient. In two examples, the bumper may be composed of silicone or TPU (thermoplastic polyurethane).

The protective apparatus may protect a valuable and/or collectible card. Such cards may be graded based on their physical condition. A higher grade typically correlates with the card being more desirable and valuable. Properties that may be graded include, for example, damage to the card, bends or breaks in the card, centering of images on the card, sharpness of the corners of the card, gloss on the card, fading of pictures, degradations of card stock quality, and the presence of any imperfections. The protective apparatus may, in some embodiments, protect the graded card from environmental elements such as dust and water.

The protective apparatus may protect a graded or valuable card and/or contain an indication of the grading system (or grade). For example, a certificate or indication on the protective apparatus may indicate a grading of the card and one or more overt or covert security features to validate the authenticity of the card and grade. The protective apparatus may protect a graded card from tampering and protect the authenticity of the graded card.

In some embodiments, the protective apparatus is rectangular and may have rounded or sharp corners. In various embodiments, the protective apparatus is square with sharp corners or a squircle, which is a shape intermediate between a square and a circle. In one embodiment, the protective apparatus is a quadrilateral and may have rounded or sharp corners. The protective apparatus consists of two or more members that may be coupled to each other (e.g., via interlocking, glue, vibration, laser, or the like). The slabs or portions may be coupled to create a chamber or cavity that may hold or store a card or other collectible. In various embodiments, the top portion and the bottom portion are adhered to one another to create a tamper-resistant seal. It will be appreciated that the protective apparatus may include any number of parts that are coupled together.

The protective apparatus may include a mask. The mask may consist of tape or an opaque material coupled to a part of the protective apparatus. In one example, the mask may surround an inner edge of the top portion of the protective apparatus. In some embodiments, the mask may cover all or part of the connection between two portions (e.g., two halves) of the protective apparatus. The mask may also cover a front portion and create the appearance of two windows on the front of the protective apparatus (e.g., a larger window and a smaller window). The front face of the protective apparatus may include a lower portion window and a more narrow, upper portion window. In some embodiments, the mask may be applied to one side of the top portion of the protective apparatus using a hot stamping method. It will be appreciated that other printing methods may be utilized to apply the mast to the top portion of the protective apparatus.

In some embodiments, a logo (e.g., “Rare Edition”), a near field communication (NFC) chip, and/or a radio frequency identification (RFID) chip may be placed in the connection between the lower portion window and the upper portion window of the top portion of the protective apparatus. The bottom portion of the protective apparatus may include four supporting members (long protrusions) that may support a card within the protective apparatus. The cavity produced by the four supporting members may correspond to the lower portion window of the top portion of the protective apparatus and may support and protect the card.

In some embodiments, each of the portions of the protective apparatus may be composed of polycarbonate. In one example, a coating may be applied to the portions of the protective apparatus to make the protective apparatus resistant to ultraviolet (UV) light and/or other types of light that may be harmful to the contained collectible. In various embodiments, a coating may be applied to the portions of the protective apparatus to make the protective apparatus scratch resistant and/or bulletproof. In one example, a scratch-resistant glass, such as CORNING® GORILLA® glass, may be applied to the surface of the protective apparatus.

Portions of the protective apparatus may be coupled together using an ultrasonic welder or laser welding. By coupling the portions together, the protective apparatus may prevent tampering (i.e., tampering may be obvious due to damage to the protective apparatus). In some embodiments, when coupled together, the protective apparatus may be waterproof or water-resistant.

In various embodiments, the removable bumper is a removable silicone bumper. The removable bumper may provide further protection to the card protector by protecting it from impact. The removable bumper may be available in different colors, allowing a user to customize or organize card protectors using different colored bumpers. In various embodiments, the removable bumper is fabricated with other materials such as thermoplastic elastomers (TPE's), latex, or rubber.

The protective apparatus may include one or more passive devices which allow the protective apparatus to communicate with an application (e.g., smartphone app) and/or grading system.

An owner of a collectible card may send a request to a grading system to grade their collectible card based on their physical condition. A higher grade typically correlates with the card being more desirable and valuable. The grading system may grade collectible cards using a deep neural network, thereby reducing the occurrence of inconsistent grading, which occurs when collectible cards are graded by humans. In some embodiments, the deep neural network is a convolution neural network (CNN). In one embodiment, the deep neural network is trained using collectible cards graded by a human. In one example, the grading system may provide rankings to collectible cards.

In some embodiments, a marketplace system may provide an online platform to connect users to sell or buy graded or ungraded collectible cards (e.g., including collectible cards protected by a protective apparatus). The marketplace system may display a virtual version of a graded card and highlight one or more parts of the graded card. The marketplace system may provide a search function that allows users to provide one or more search criteria to a marketplace interface. The marketplace system may provide digital images of one or more collectible cards.

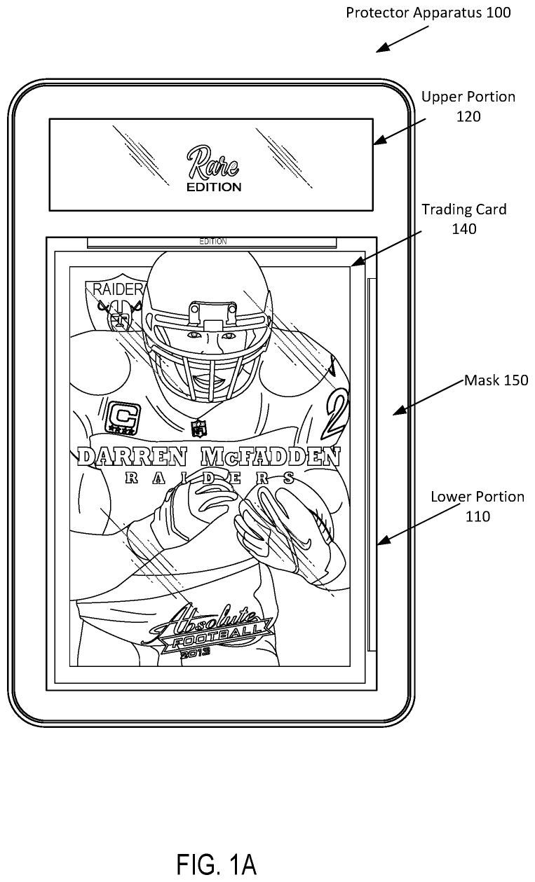

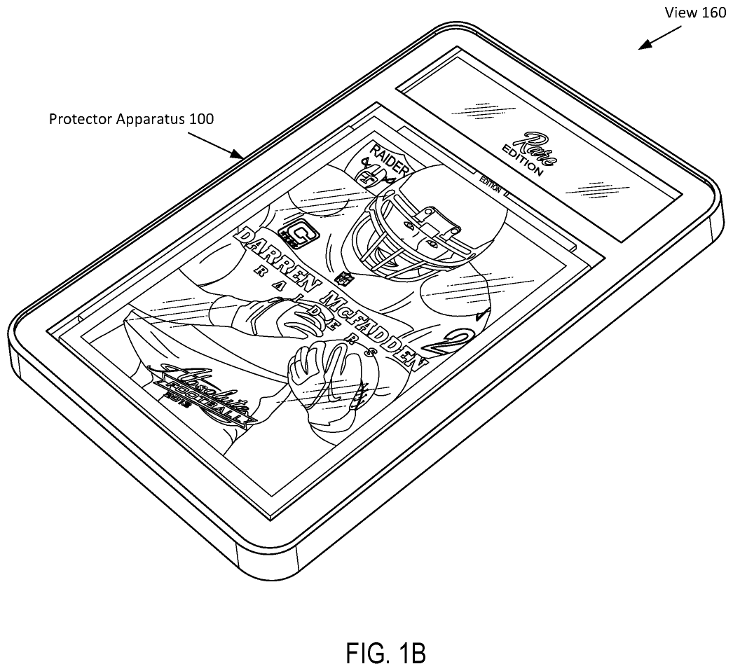

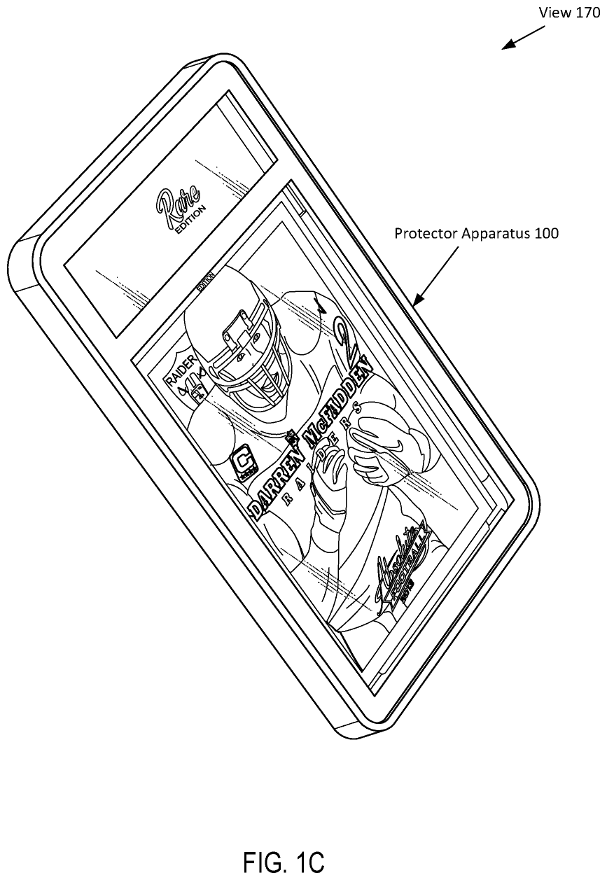

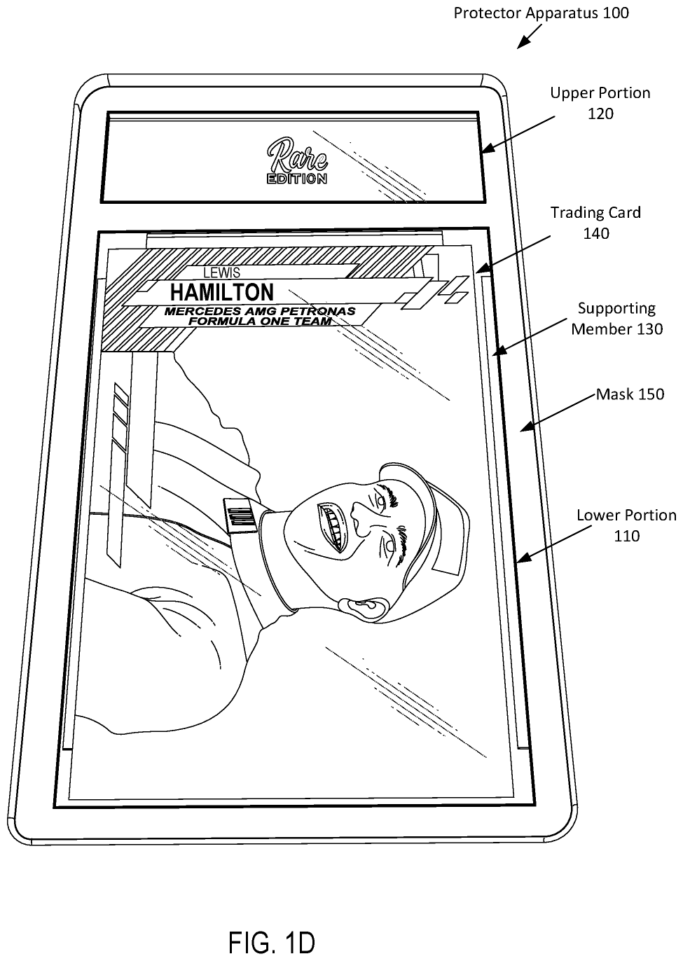

FIG. 1A depicts a perspective view of a protective apparatus 100 with a bumper in some embodiments. In this example, the protective apparatus 100 includes a lower portion 110, an upper portion 120, and a mask 150. In the example of FIG. 1A, the protective apparatus 100 is rectangular and has rounded corners.

The protective apparatus 100 may include a front panel coupled to a back panel. The front panel and/or the back panel may contain supporting members and protective members (e.g., formed from plastic or any material) configured to keep the front panel and the back panel coupled and to position the collectible object. The front panel and the back panel are further discussed herein.

In various embodiments, the front panel and/or the back panel may be transparent thereby allowing the collectible card to be viewed through the protective apparatus.

The lower portion 110 may be or include a window, holder, cavity, or the like configured to display a collectible object such as a trading card 140. The lower portion 110 may be transparent or include a transparent material (e.g., the lower portion 110 may include a window) to display the collectible object. Behind the transparent window, the protective apparatus 100 may include a holder, retaining members, and the like for positioning and holding the media (e.g., autograph, logo, or the like) for display through the lower portion 110.

There may be a cavity configured to hold, position, and protect the collectible object behind the transparent window of the lower portion 110.

In some embodiments, the lower portion 110 may have a width of approximately 64.5 millimeters (mm) and a length of approximately 90 mm. The protective apparatus 100 may include any number of rectangular supportive members to position and reduce movement of the collectible object for consistent display through the lower portion 110.

The upper portion 120 may be a window, holder, cavity, or the like configured to display information such as a logo, grading system, card name, collectible name, autograph, or the like. The upper portion 120 may be transparent (e.g., the upper portion 120 may include a window) as well as a cavity for holding other media (e.g., a card, plastic, photograph, or other media) for protection and display through the upper portion 120. For example, the upper portion 120 may include a transparent window. Behind the transparent window, the protective apparatus 100 may include a holder, retaining members, and the like for positioning and holding the media (e.g., autograph, logo, or the like) for display. Alternatively, the upper portion 120 may include a media coupled to the upper portion 120. The coupled media may be plastic, metallic, paper, or the like. The coupled media may, in some embodiments, display information or be blank.

A view 160 of FIG. 1B depicts a perspective view of the protective apparatus 100 from a different angle.

A view 170 of FIG. 1C depicts another perspective view of the protective apparatus 100 from a different angle.

In some embodiments, the protective apparatus 100 may include one or more supporting members positioned along the perimeter or boundaries of the lower portion 110 or the upper portion 120. The supporting members may assist in strengthening the protective apparatus 100 and/or position the collectible object or information contained within the protective apparatus 100.

In one embodiment, the mask 150 may consist of tape or an opaque material coupled to a back face of the top portion of the protective apparatus 100. The mask 150 may cover all or part of the connection between two portions (e.g., two halves) of the protective apparatus.

In some embodiments, the upper portion 120 and the lower portion 130 may be part of a single rectangular window. The mask 150 may extend through the single rectangular window to create the appearance of two windows. In some embodiments, the mask 150 may be applied to one side of the top portion of the protective apparatus using a hot stamping method. It will be appreciated that other printing methods may be utilized to apply the mast to the top portion of the protective apparatus.

In some embodiments, a logo, an NFC chip, or an RFID chip may be contained within or upon the protective apparatus 100. In one example, the logo, NFC chip, and/or RFIC chip may be positioned or coupled to the protective apparatus 100 between the upper portion 120 and the lower portion 110. In some embodiments, there may be a logo, NFC chip, and/or RFID chip anywhere between or on the top or bottom portions.

In one embodiment, the user may interact with the radio frequency identification device (RFID) tag or near field communication (NFC) chip using a mobile computing device with a software application installed thereon. The user may bring a mobile computing device, such as a smartphone, in proximity to the protective apparatus 100. When a user interacts with the RFID tag or NFC chip, the user may be provided with an address or be directed to navigate to a webpage containing information regarding the card and/or rating system. FIG. 1D depicts another frontal view of the protective apparatus 100.

In some embodiments, the webpage or card information may include digital images or videos of the collectible card. The webpage or card information may include details of the physical condition of the collectible card and grading information such as overall features that impact value (e.g., rareness of the card, features that were used to grade the card), quality of the card, and/or any damage that may impact grading. The webpage or card information may include links or information describing the grading process, what was taken into account for the particular card protected by the protective apparatus, aspects of the card that positively or negatively impacted grading, and the like. In some embodiments, the webpage or card information includes sufficient information that the card can be consistently graded given the methodology and the facts that are provided.

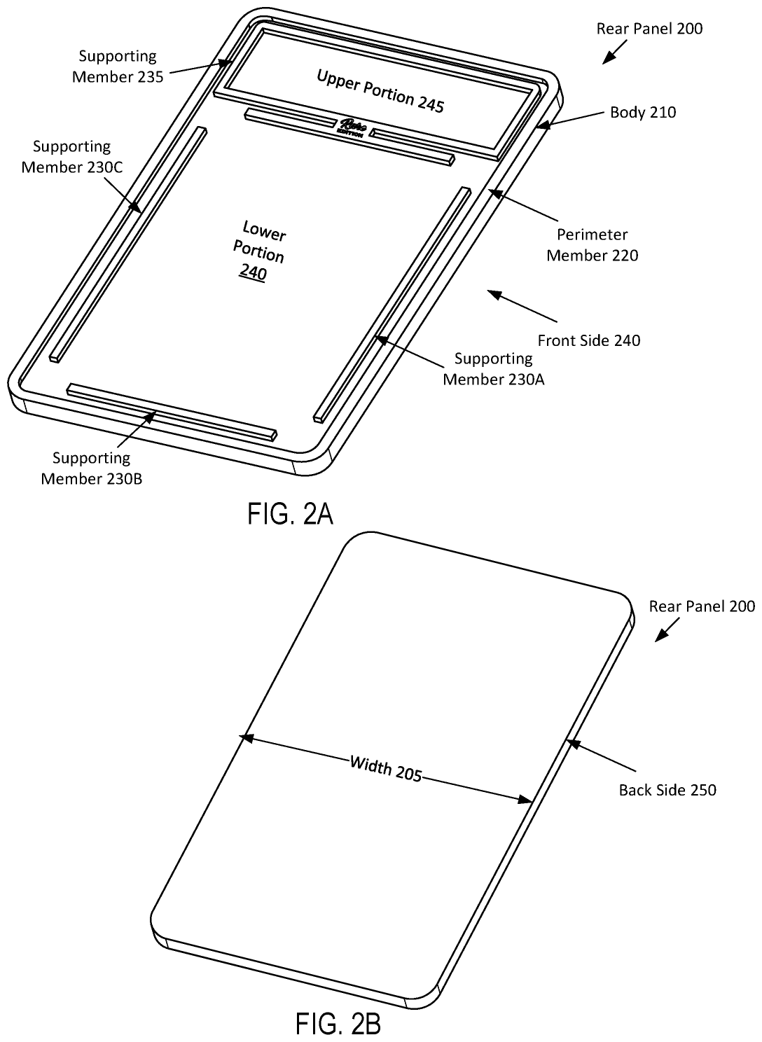

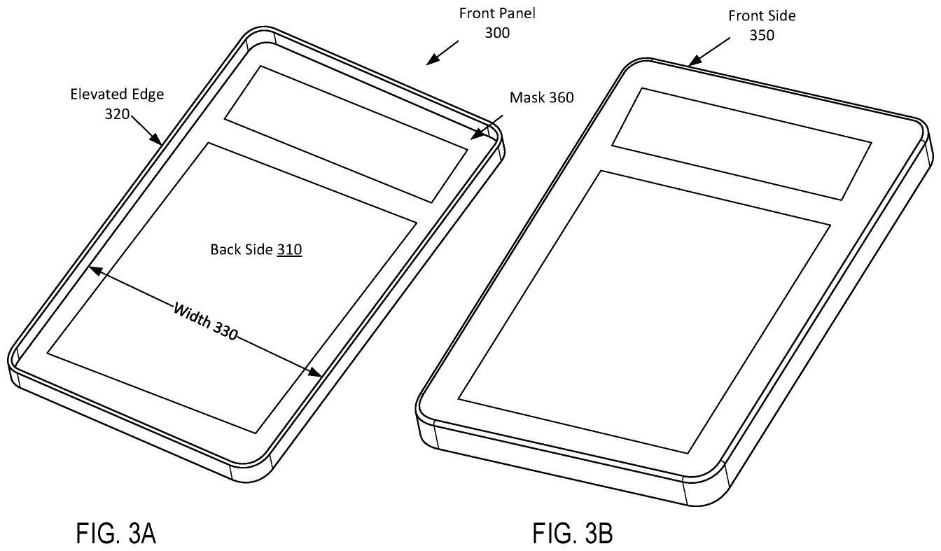

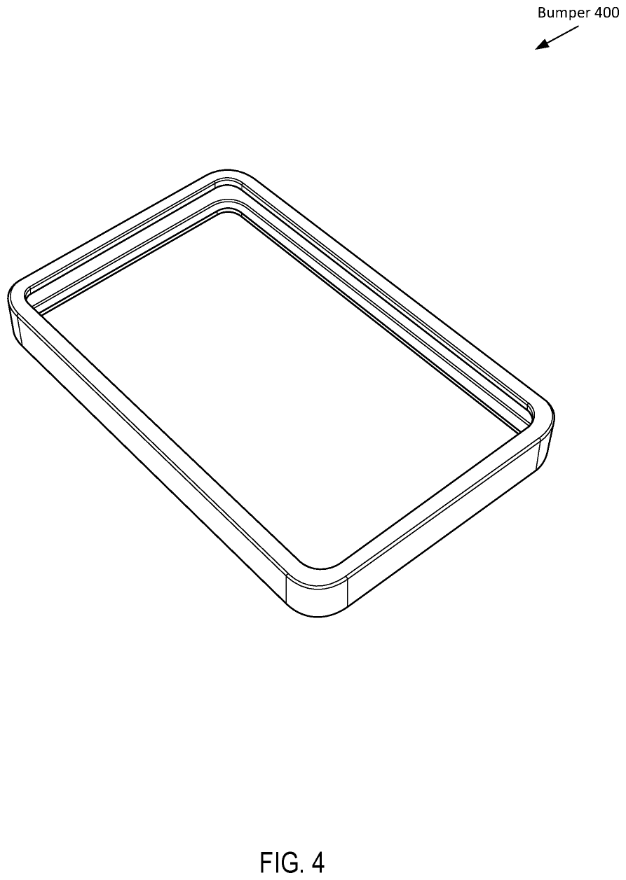

In some embodiments, the protective apparatus 100 consists of two or more panels coupled together to create one or more cavities that may hold or store a card or other collectible. The protective apparatus 100 may comprise the rear panel 200 (see FIGS. 2A and 2B) and the front panel 300 (see FIGS. 3A and 3B).

In various embodiments, the front panel and the rear panel are adhered to one another to create a tamper-resistant seal as further discussed herein.

Either or both panels may be comprised of polycarbonate, metal, alloy, or any material. In various embodiments, the front panel 300 and the rear panel 200 may be made of polycarbonate. It will be appreciated that polycarbonate is more impact resistant than polystyrene and provides ultraviolet (UV) light protection over polystyrene. For this reason, polycarbonate may be preferable over polystyrene or other materials to protect the collectible objects from impacts of the protective apparatus 100 and UV light.

FIG. 2A depicts a front side 240 of a rear panel 200 in some embodiments. FIG. 2B depicts a back side 250 of the rear panel 200 in some embodiments. The front side 240 of the rear panel 200 is typically on the inside of the protective apparatus 100 when the rear panel 200 is joined to the front panel 300. The back side 250 is typically on the back, outward facing side when the rear panel 200 and the front panel 300 are joined.

The back side 250 of the rear panel 200 depicted in FIG. 2A includes a body 210 with a perimeter member 220 disposed along the perimeter of one side of the body 210. The perimeter member 220 may allow the front panel 300 and the rear panel 200 to be held together and/or may be used to hold the two halves together (e.g., through sonic or laser welding). In various embodiments, the perimeter member 220 may prevent debris from entering into the protective apparatus 100. Further, the perimeter member 220 may assist in reducing opportunities to tamper with the protective apparatus 100, reducing opportunities to tamper with a security feature of the protective apparatus 100 (e.g., NFC chip, hologram, RFID, or the like), or reducing opportunities to tamper with the collectible object. Laser welding may also assist to reduce the opportunity for water to enter into the protective apparatus 100.

In various embodiments, the perimeter member 220 is laser welded to the elevated edge 320 (discussed with regard to FIG. 3A). By laser welding the rear panel 200 and the front panel 300 may assist to prevent water from entering the protective apparatus 100 if the apparatus gets wet or is submerged. Further, laser welding the perimeter member 220 to the elevated edge 320 may prevent debris from entering into the protective apparatus 100, may reduce opportunity to tamper with the collectible object, and/or reduce opportunity to tamper with the security feature(s) of the protective apparatus 100 (e.g., NFC chip, hologram, RFID, or the like).

Supporting members 230A, 230B, and 230C are rectangular protrusions that may assist in holding or positioning the collectible object. There may be any number of supporting members. In various embodiments, there is another supporting member that holds or positions one of the sides of the collectible object. The supporting members 230A, 230B, and 230C may be any shape such as rectangular, circular (e.g., posts), polygonal, and/or the like. There may be any number of supporting members 230A, 230B, and 230C.

The supporting members 230A, 230B, and 230C (and any other supporting member) may extend the depth of the cavity defined by the rear panel 200 and the front panel 300 when joined together. For example, when the rear panel 200 and the front panel 300 are joined together, the supporting members 230A, 230B, and 230C may extend from the rear panel 200 to the front panel 300 without a gap (or with only a small gap). There may be any number of supporting members. The supporting members may assist in holding the collectible object and/or providing strength and rigidity to the protective apparatus 100.

In various embodiments, supporting members 230A, 230B, and 230C may be welded (e.g., sonically welded) such that the rear panel 200 and the front panel 300 are securely held.

While FIG. 2A depicts three supporting members 230A, 230B, and 230C that are positioned to hold sides of the collectible object, it will be appreciated that there may be any number of supporting members. For example, in some embodiments, there may be only one supporting member that forms a perimeter about a cavity configured to hold the collectible object. In another example, rear panel 200 may include supporting members configured to hold corners of the collectible object and/or sides of the collectible object.

The rear panel 200 may be formed by injection molding along with the supporting members 230A, 230B, and 230C. In some embodiments, the supporting members 230A, 230B, and 230C are removable and able to be coupled to different places of the front side 240 of the rear panel 200 thereby allowing the protective apparatus 100 to hold and retain different sizes of collectible cards. In various embodiments, the supporting members may include supporting posts or protrusions that may fit in any number of holes positioned at specific spacing in the rear panel 200 or the front panel 300. The supporting members may be positioned using different sets of holes to allow different sizes and shapes of collectible objects to be held. In some embodiments, the supporting members may include magnets (e.g., rare earth magnets) that allow the supporting members to be held in place at different positions. In other embodiments, the supporting members may be adhered (e.g., using glue or melted plastic) to different positions to enable holding of different sizes of collectible objects.

The supporting member 235 may be any shape. As depicted in FIG. 2A, the supporting member 235 forms a perimeter about the upper portion 245 and extends towards the lower portion 240 to form a barrier to retain or hold a side of the collectible object. The supporting member 235 surrounding the upper portion 245 may be configured to retain, protect, or hold paper, media, or the like containing information such as a logo, information regarding the collectible object, a grade, a grading system, a security measure (e.g., holograph), and/or the like. In this example, a logo is etched upon the supporting member 235 between the perimeter about the upper portion 245 and the portion of the supporting member 235 that is configured to hold the collectible object. The logo may be visible through the front panel 300 (e.g., through a window of the front panel 300).

In various embodiments, the supporting member 235 may only surround the upper portion 245 and there may be another rectangular member that forms a fourth supporting member to work with supporting members 230A, 230B, and 230C to hold the collectible object.

The rear panel 200 may include any number of supporting members and the supporting members may be of any shape. For example, the protective apparatus 100 may include a supporting member that surrounds the lower portion 240 (e.g., the supporting member may be a rectangle that surrounds the lower portion 240 much like the supporting member surrounds the upper portion 245).

FIG. 2B depicts a back side 250 of the rear panel 200 that makes up the card protector in some embodiments. In some embodiments, the rear panel 200 may be transparent, semi-transparent, or opaque. The back side 250 may be of any texture. In various embodiments, the back side 250 includes or retains security features (e.g., such as an NFC chip, RFID, a hologram, and/or the like).

Although the back side 250 in FIG. 2B is featureless, it will be appreciated that there may be information on the back side 250 such as information about the collectible card, grading system, features of the protective apparatus 100, and/or the like.

In some embodiments, the back side 250 includes a transparent window similar to the transparent window on the front panel 300 that is configured to depict a side of the collectible object. In one example, when the collectible object is a sports card, the front panel 300 may include a transparent window allowing a user to view the image of the athlete on the front of the sports card and the rear panel 200 may include a transparent window (e.g., of the same size and shape of the transparent window of the front panel 300) to display the athlete's athletic statistics or other information from the back of the collectible card.

In various embodiments, the front side 350 of the front panel 300 of the protective apparatus 100 is transparent or semi-transparent. In some embodiments, the back side 250 of the rear panel 200 has a matte or glossy surface. In some embodiments, the rear panel 200 and the front panel 300 comprises or is covered by a strong, transparent panel, such as CORNING® GORILLA® glass, to provide added protection to the card protector. It will be appreciated that the protective apparatus may be fabricated of many different materials, including, for example, a combination of materials such as polycarbonate with cut outs that are coupled to a stronger material.

In some embodiments, the perimeter member 220 may have a height of 1.5 mm from the surface of the body 210. In some embodiments, the rear panel 200 may have a width 205. The width 205 of the rear panel 200 may be 80.33 mm.

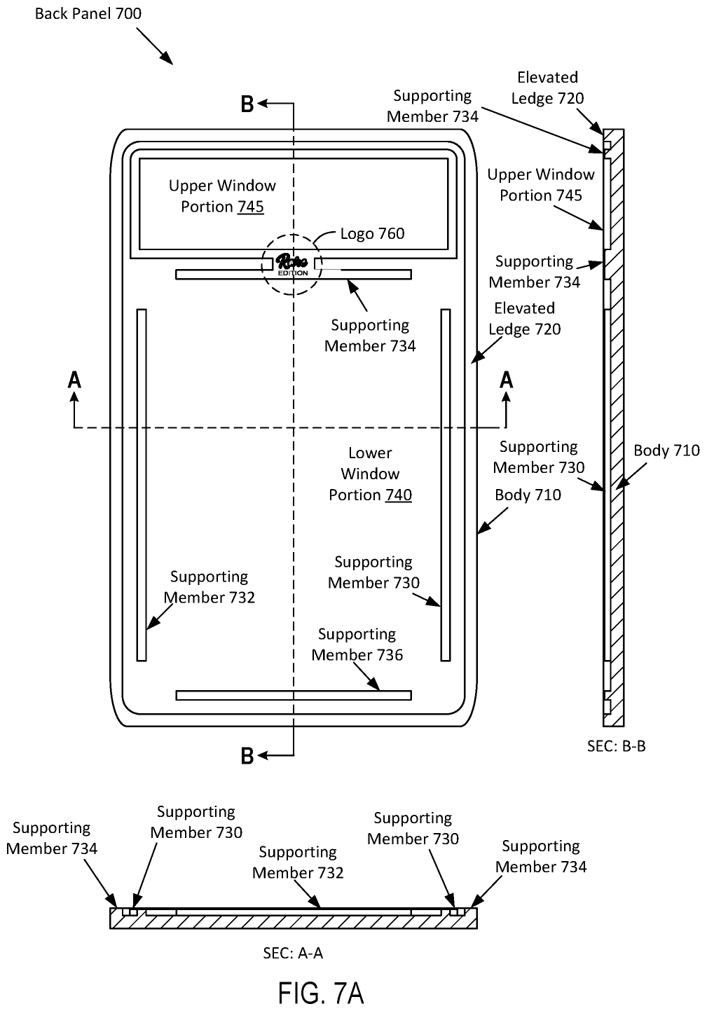

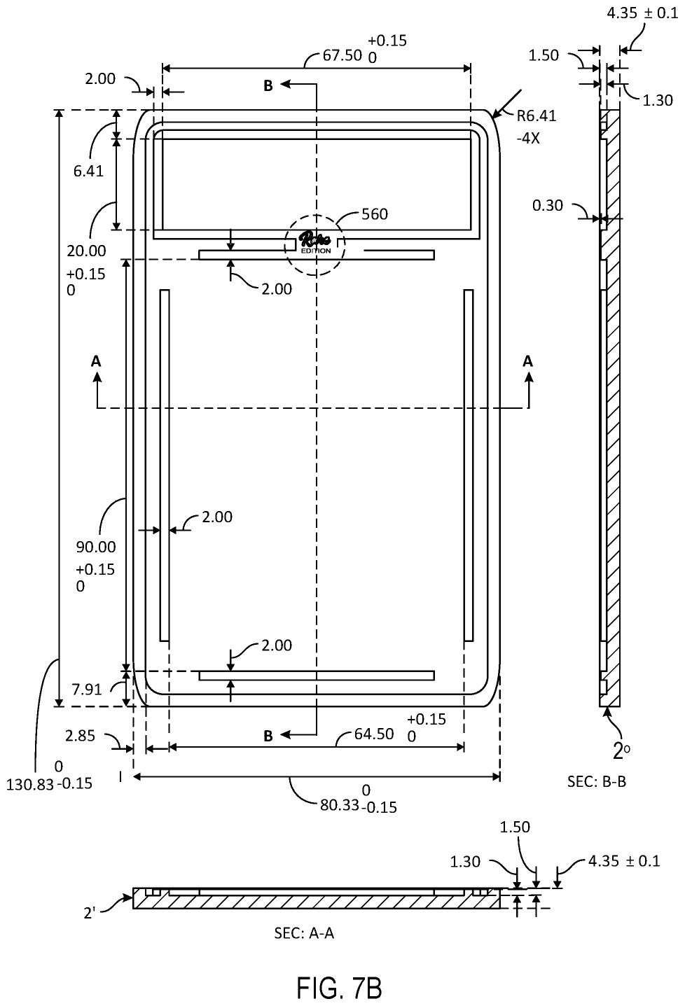

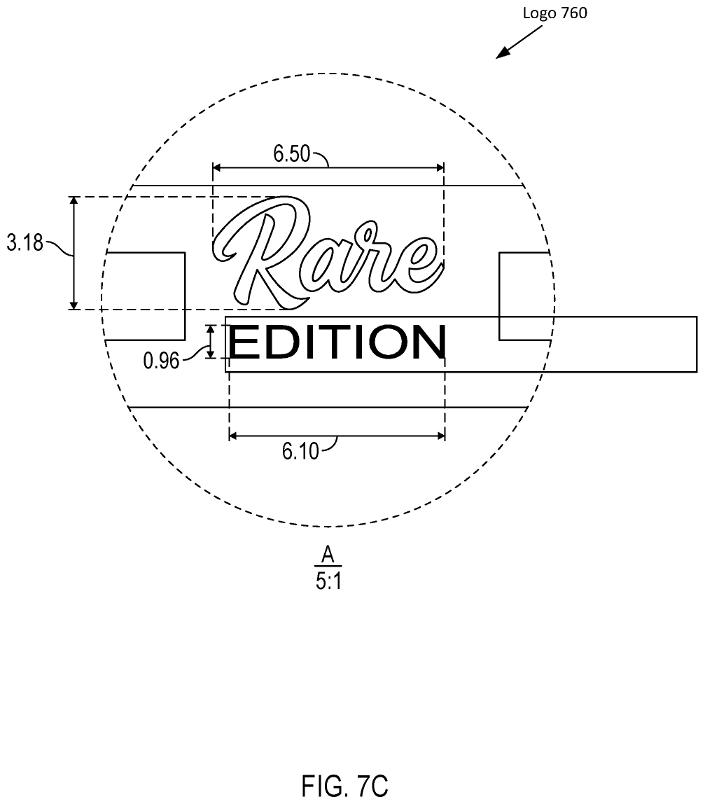

In some embodiments, multiple supporting members 230 and 235 are arranged on one side of the rear panel 200 to create a lower window portion 240 as depicted in the FIG. 2A. When the rear panel 200 is coupled to a front panel, the lower window portion 240 created by the multiple supporting members 230 defines the lower portion 110 of FIG. 1A. The placement of the multiple supporting members 230 may be configured to accommodate collectible cards, trading cards, and game cards of different sizes. The multiple supporting members 230 and 235 may be composed of polycarbonate. As seen in FIG. 7B, the card protector can accept a card with a length of approximately 90 mm and a width of approximately 64.5 mm. In some embodiments, the multiple protrusions of the lower portion wall have a width of approximately 2 mm. In some embodiments, the protective apparatus is an archival-safe product.

In some embodiments, the supporting member 235 may define the upper window portion 245 as well as an upper limit of the lower window portion 240. The supporting member 235 may have a shape that is different from that of the multiple supporting members 230. In some embodiments, the supporting member 235 may also create an upper window portion 245. In the illustrated embodiment, the supporting member 235 is fabricated and arranged on the front side of the rear panel 200 to generate an enclosed perimeter of the upper window portion 245. In one example, multiple supporting members are fabricated and arranged to generate a perimeter of the upper window portion 245. More details regarding the measurements of the various components of the rear panel 200 will be discussed in FIG. 7A.

In some embodiments, a logo may be placed on the supporting member 235 in the area between the lower window portion 240 and upper window portion 245. The logo may be embossed into the supporting member 235. In various embodiments, a hot stamping method may be used to give the logo color. Hot stamping may be necessary to make an impression on polycarbonate.

FIG. 3A depicts a back side 310 of a front panel 300 that makes up the protective apparatus 100 in some embodiments. The front panel 300 may be completely or a portion may be transparent. In various embodiments, mask 360 is an opaque material (e.g., tape, paper, or the like) adhered or otherwise coupled to the inside (e.g., back side 310) of the front panel 300. The mask 360 may be positioned along the perimeter of the back side 310 of the front panel 300. The mask 360 may form windows (e.g., an upper window and a lower window) in the front panel 300 thereby allowing the collectible object to be viewed through the lower window. The lower window may be the size of the collectible object (e.g., the lower window may be the length and width of a collectible card). The upper window may be the same width as the lower window. The upper window may be shorter than the lower window. The upper window my display media (e.g., paper, plastic, logo, hologram, information, and the like). It may be appreciated that the mask 360 may define any number of windows of any size or shape.

When the front panel 300 is coupled with the rear panel 200, the mask 360 will be within the protective apparatus 100.

It may be appreciated that the mask 360 may be optional. In various embodiments, the front panel 300 may be a combination of materials such as a transparent window (e.g., the upper window and the lower window) surrounded by opaque or semi-transparent materials.

Similar to the rear panel 200 of FIG. 2A, the front panel 300 may include an elevated edge 320 that is fabricated and arranged along the perimeter of a body of the front panel 300. The elevated edge 320 may be coupled with the back panel 200 and/or the perimeter member 220 to hold the rear panel 200 and the front panel 300 together. For example, the top of the elevated edge 320 and or a side of the elevated edge 320 may be melted or fused with the back panel 200 and/or the perimeter member 220, thereby securing the collectible object, preventing debris from entering into the protective apparatus 100, and/or preventing tampering.

The front panel 300 may be in a rectangular shape. In various embodiments, the back side 310 has a width and length that is the same or substantially the same as a width and length of the rear panel 200 of FIG. 2A. In some embodiments, the front panel 300 is composed of polycarbonate. In various embodiments, the elevated edge 320 is a single-piece polycarbonate. In one example, the elevated edge 320 includes multiple pieces of polycarbonate adhered together.

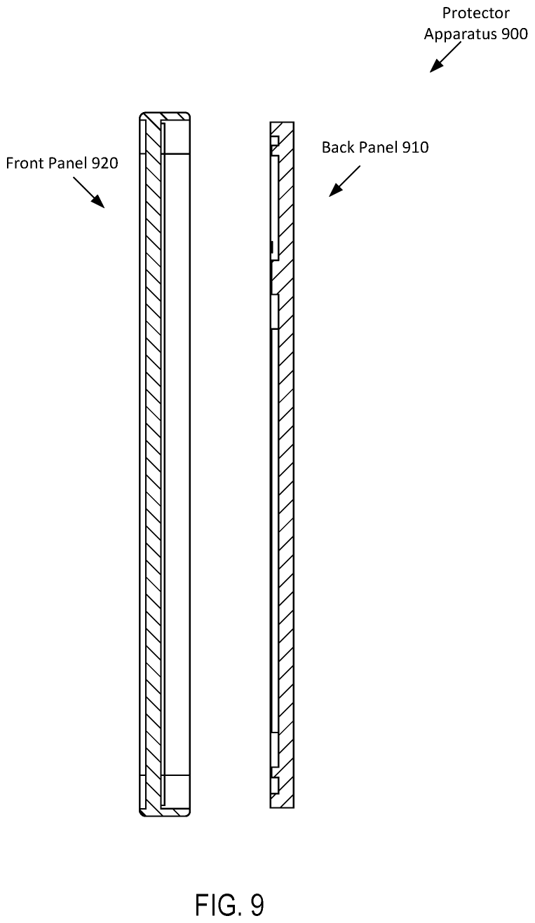

In one example, the front panel may have a length and width that is greater than that of the rear panel 200, such that the rear panel 200 may be placed in an opening of the front panel before the protective apparatus is coupled together using an ultrasonic welder or laser welding. An example of this configuration of the rear panel 200 and front panel 300 may be seen in FIG. 9 which depicts a cross section of the panels of the protective apparatus. In some embodiments, a cavity of the front panel 300 created by the elevated edge 320 may have a width 330 that is the same or substantially the same as the width 205 of the rear panel 200.

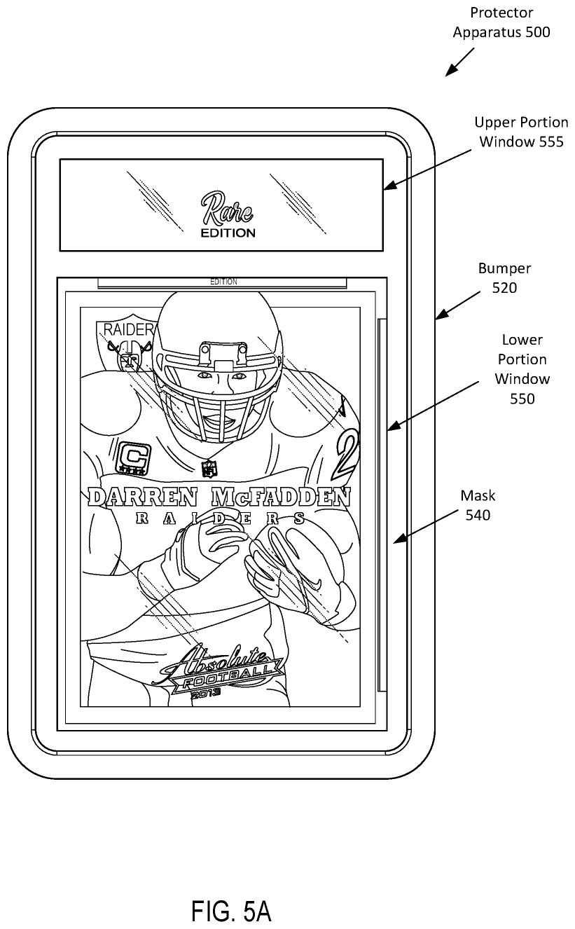

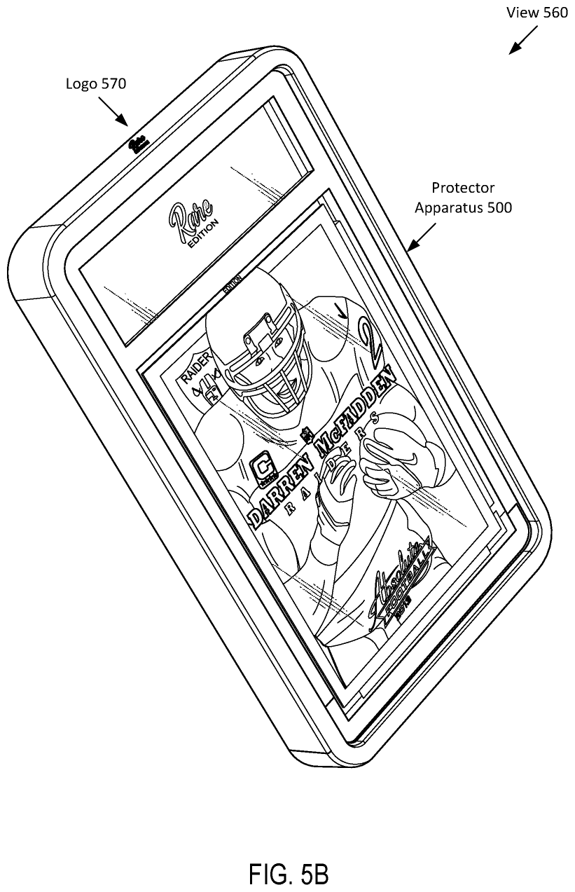

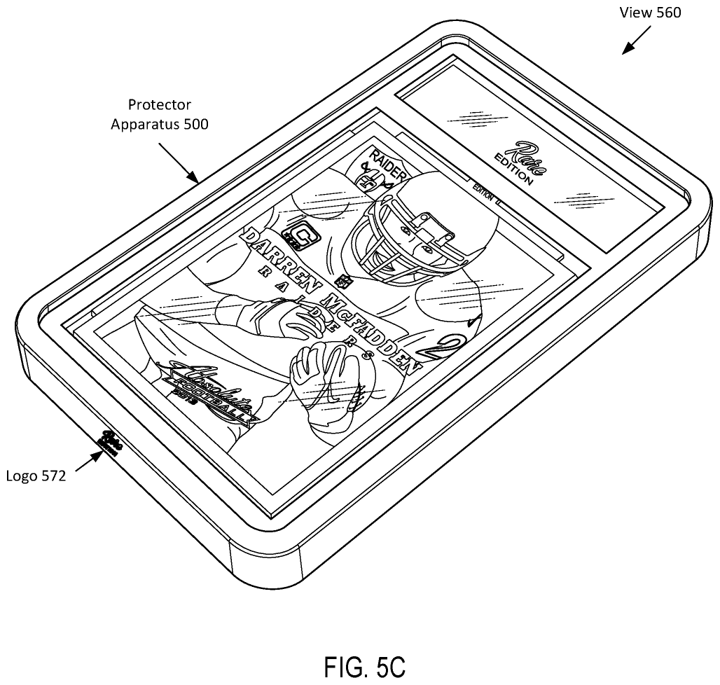

FIG. 3B depicts a front side 350 of the front panel 300 that makes up the protective apparatus 100 in some embodiments. In some embodiments, the front panel 300 may be transparent or semi-transparent. In various embodiments, a scratch-resistant glass, such as CORNING® GORILLA® glass, may be applied to the front side 350 of the front panel 300. The front panel 300 and the rear panel 200 of FIG. 2A may be assembled into a card protector, such as a protective apparatus 500 of FIG. 5A.

The front panel 300 may include transparent windows for the upper portion and the lower portion discussed herein. In various embodiments, the front panel 300 is predominantly transparent (e.g., except for the elevated edge 320) and a mask (e.g., mask 150) may cover all or part of the front side 350 of the front panel 300 to form any number of windows.

FIG. 4 depicts a perspective view of a bumper 400 according to some embodiments. The bumper 400 may be composed of any resilient material such as silicone, thermoplastic elastomers (TPEs), latex, or rubber.

In some embodiments, the bumper 400 consists of a single piece of silicon fabricated into a shape that allows the bumper 400 to surround or protect the protective apparatus. In one example, the bumper 400 may be placed around the outer perimeter of the protective apparatus 100 of FIG. 1A. In various embodiments, the bumper 400 is removable and provides further protection to the card protector by protecting the card protector from the impact of falls or bumps.

The bumper 400 may be removable. In some embodiments, the bumper 400 is adhered or fastened to the protective apparatus 100 as a further security feature to avoid tampering.

FIG. 5A depicts a front view of another protective apparatus 500 with a bumper in some embodiments. The protective apparatus 500 includes a bumper 520. The protective apparatus 500 may be similar to the protective apparatus 100 of FIG. 1A. A view 560 of FIG. 5B shows the protective apparatus 500 from another perspective.

The protective apparatus 500 includes a mask 540. The mask 540 may adhere the top of the protective apparatus 500 or from within inside the front panel of the protective apparatus 500. The mask 540 may include an opaque material coupled to the front panel of the protective apparatus 500 to create a lower portion window 550 and an upper portion window 555. Alternately, there may be a lower portion window 550 and an upper portion window 555 defined by the front panel (e.g., there may be two transparent windows retained or within the front panel of the protective apparatus 500) and the mask 540 is ornamental and/or may cover security features discussed herein.

In some embodiments, the mask 540 may be black in color. In some embodiments, the mask may be applied to one side of the top portion of the protective apparatus using a hot stamping method. It will be appreciated that other printing methods may be utilized to apply the mask to the top portion of the protective apparatus.

In some embodiments, the mask 540 may hide the appearance of the supporting members, such as the supporting members 230 and 235 of FIG. 2A. In various embodiments, a logo (e.g., “Rare Edition”) may be placed in or on an area of the mask 540 between the lower portion window 550 and the upper portion window 555. In one embodiment, NFC chip and/or RFID tags may be placed in the protective apparatus 500 as an added authentication or certification feature. The NFC chip and/or RFID tag may be hidden by the mask 540. In some embodiments, the NFC chip and/or RFID tag may be within the protective apparatus 500.

In some embodiments, the user may interact with the RFID tag or NFC chip using a mobile computing device with a software application installed thereon. The user may bring a mobile computing device, such as a smartphone, in proximity to the protective apparatus 500. When a user interacts with the RFID tag or NFC chip, the user may be provided with an address or be directed to navigate to a webpage containing information regarding the card and/or rating system.

In some embodiments, the webpage or card information may include digital images or videos of the collectible card. The webpage or card information may include details of the physical condition of the collectible card and grading information such as overall features that impact value (e.g., rareness of the card, features that were used to grade the card), quality of the card, and/or any damage that may impact grading. The webpage or card information may include links or information describing the grading process, what was taken into account for the particular card protected by the protective apparatus, aspects of the card that positively or negatively impacted grading, and the like. In some embodiments, the webpage or card information includes sufficient information that the card can be consistently graded given the methodology and the facts that are provided.

In some embodiments, the protective apparatus 500 is transparent or semi-transparent. In some embodiments, the front side of the top portion of the protective apparatus has a matte or glossy surface.

The bumper 520 may be removable to provide further protection to the card protector by protecting it from the impact of falls or drops. In one embodiment, the removable bumper is available in different colors, allowing a user to customize or organize card protectors using different colored bumpers. In various embodiments, the removable bumper is fabricated with other materials such as thermoplastic elastomers (TPEs), latex, or rubber. A logo, such as a logo 570, as seen in FIG. 5B may be fabricated on the top of bumper 520. In some embodiments, a logo 572 may be fabricated on the bottom of the bumper, as seen in FIG. 5C.

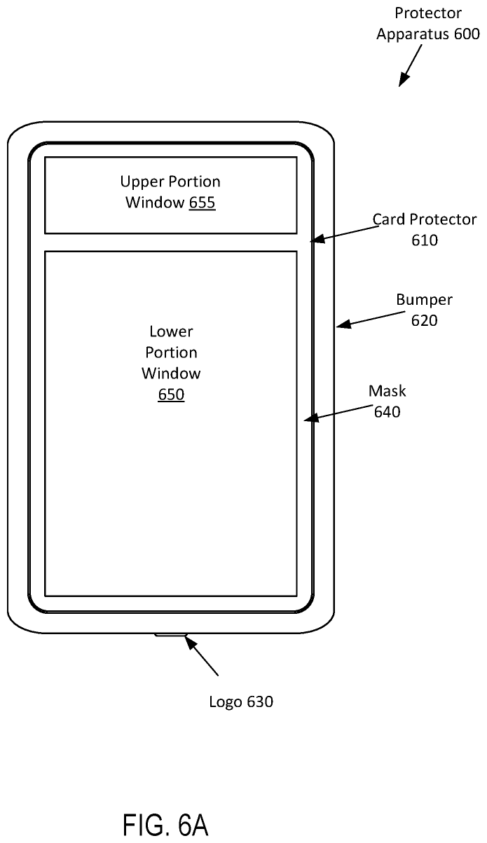

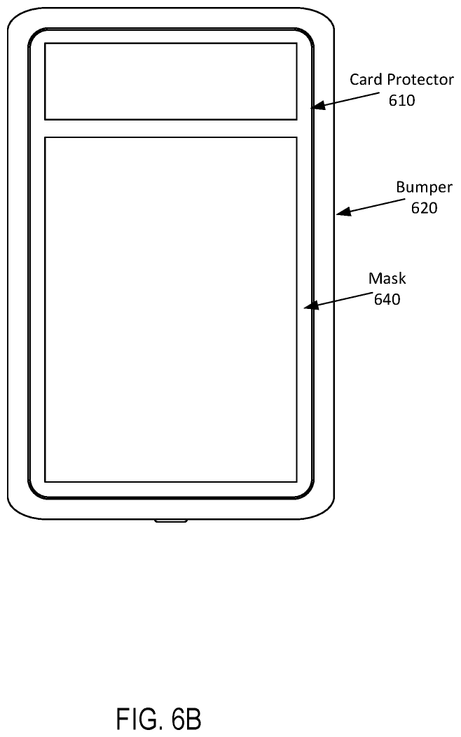

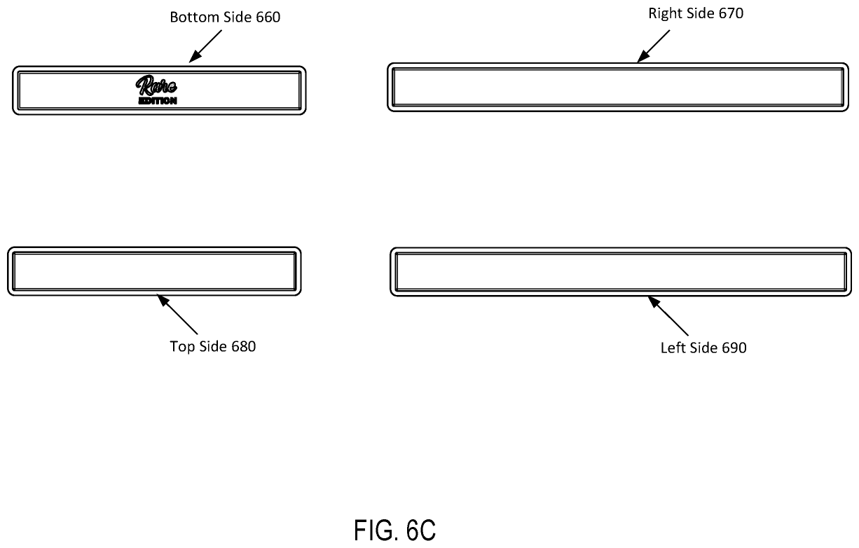

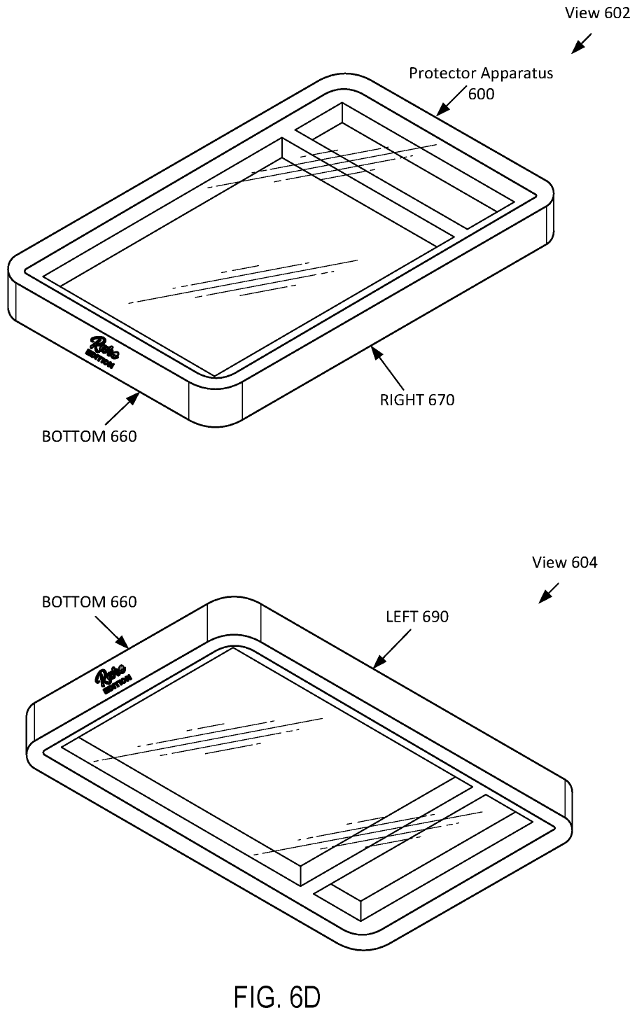

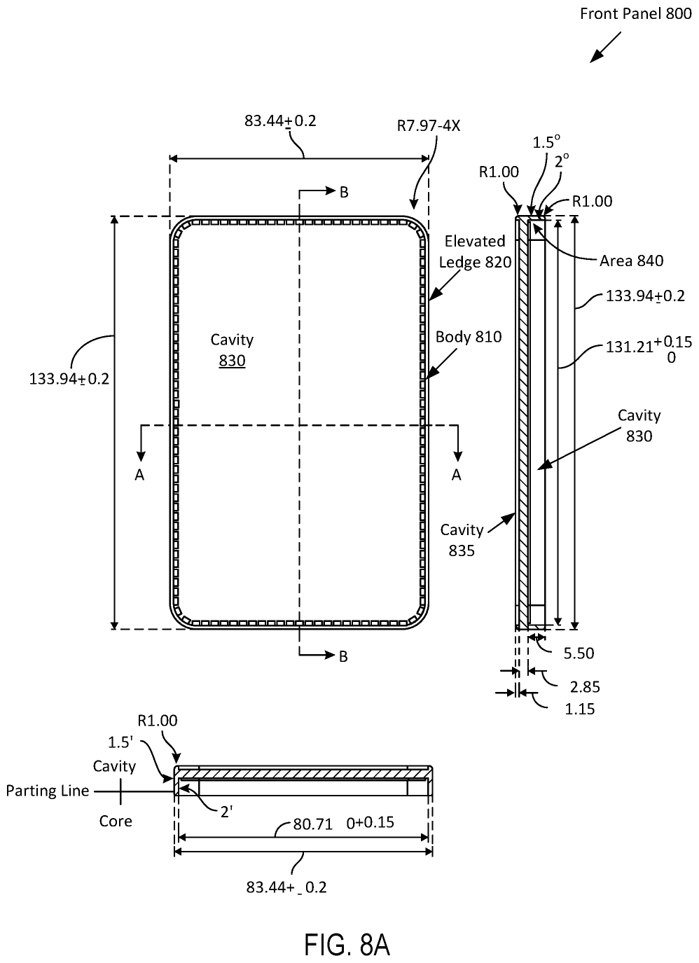

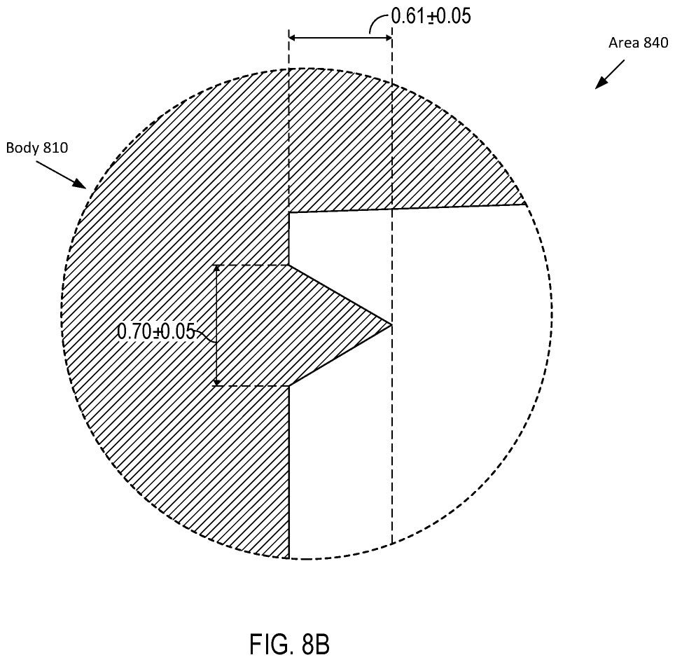

FIG. 6A depicts a view of a front side of a protective apparatus 600 in some embodiments. The protective apparatus 600 includes a card protector 610 and a bumper 620. The card protector 610 may be similar to the protective apparatus 100 of FIG. 1A. Views 602 and 604 of FIG. 6D depicts the protective apparatus 600 from different perspectives. The bumper 620 may be removable to provide further protection to the card protector by protecting it from the impact of the card protector. In one embodiment, the removable bumper is available in different colors, allowing a user to customize or organize card protectors using different colored bumpers. In some embodiments, a logo 630 may be fabricated at the bottom of the bumper 620. The logo 630 may be seen in FIG. 6C. FIG. 6C depicts various views of the protective apparatus, including a bottom side 660, a right side 670, a top side 680, and a left side 690. More views of the protective apparatus may be seen in FIG. 8A and 8B.

The card protector 610 includes a mask 640. The mask 640 may be adhered to a back side of a front panel which makes the card protector 610. The mask 640 may include an opaque material coupled to the front panel of the card protector 610 to create a lower portion window 650 and an upper portion window 655.

FIG. 6B depicts a view of the back side of the card protector 610 with bumper 620 in some embodiments. Similar to the front side of the protective apparatus 600 of FIG. 6A, the back side of the card protector 610 is transparent, semi-transparent, or opaque.

FIG. 7A depicts a back panel 700 and cross-sections of the back panel in some embodiments. For simplicity, measurements of various components of the back panel 700 can be found in FIG. 7B. In the illustrated embodiment of FIG. 7B, measurements of various aspects of the card protector are shown, such as the length of 90 mm and width of 64.5 mm of the lower window portion. A fabrication tolerance for one or more of the components may also be found in FIG. 7B, for example, The width of the back panel 700 may be 80.33 mm. It can be appreciated that the measurements of the card protector may be different.

The back panel 700 includes a body 710 with an elevated ledge 720. The body 710 may be a horizontal sheet of polycarbonate in a rectangular shape and may have rounded or sharp corners. In various embodiments, the body 710 is a quadrilateral and may have rounded or sharp corners. The body 710 may be composed of polycarbonate or polystyrene. In some embodiments, the body 710 may have a height of 2.85 mm, a length of 130.83 mm, and a width of 80.33 mm.

The elevated ledge 720 runs along the perimeter of the body 710. In one embodiment, the elevated ledge 720 has a width of 2.85 mm and a height of 1.5 mm from the surface of the body 710. The elevated ledge 720 may provide further protection from water and dust from getting into the lower window portion and the card placed therein.

The back panel 700 further includes supporting members 730 and 732 that are fabricated and arranged on a front side of the back panel 700 to create a lower window portion 740. In some embodiments, the supporting members 730 and 732 may have a width of 2.00 mm. When the back panel 700 is coupled to a front panel, the lower window portion 740 created by the supporting members 730 and 732 defines the lower portion 110 of FIG. 1A. In some embodiments, the perimeter of the lower window portion 740 may be fabricated from a single supporting member similar to the enclosed perimeter of the upper window portion 745.

The placement of the supporting members 730, 732, and 736 may be configured to accommodate collectible cards, trading cards, and game cards of different sizes.

The supporting members 730, 732, and 736 may be composed of polycarbonate or TPU (thermoplastic polyurethane). In one example, the supporting members 730, 732, and 736 may be composed of TPU while the protector apparatus 100 may be compose of polycarbonate. The supporting members 730, 732, and 736 may be composed of TPU to hold but not damage the card/collectible. Further, the TPU of the supporting members 730, 732, and 736 may also lessen the chance of a card/collectible getting damaged from shaking. As seen in FIG. 7A, the card protector can accept a card with a length of approximately 90 mm and a width of approximately 64.5 mm.

In some embodiments, a supporting member 734 defines the upper window portion 745 as well as an upper limit of the lower window portion 740. The supporting member 734 may have a shape that is different from that of the supporting member 732. In some embodiments, the supporting member 734 may include a protrusion that has the same dimensions as the supporting member 732 as well as defining an enclosed perimeter of the upper window portion 745. In some embodiments, the supporting member 734 has a width of 2.00 mm and a height of 1.3 mm. In one example, the upper window portion 745 has a width of 67.5 mm and a length of 20 mm.

Similar to the supporting members 730, 732, and 736, supporting member 734 may be composed of any resilient material. For example, the supporting member 734 may be composed of polycarbonate or TPU. In one example, the supporting members 730, 732, 734, and 736 may be composed of TPU while the protector apparatus 100 may be compose of polycarbonate. It will be appreciated that in some embodiments, the different supporting members 730, 732, 734, and 736 may be compose of different materials (or different combination of materials).

In various embodiments, a logo (e.g., “Rare Edition”) 560 may be stamped or molded into the supporting member 734. The logo 760 has a height/depth of 0.3 mm. Further details regarding the logo may be discussed in FIG. 7C.

The upper window portion 745 may support a grading card. The grading card may be a certificate indicating a score or category of the card based on the properties of the card. Properties may include, for example, centering of images on the card, sharpness of the corners of the card, gloss on the card, fading of pictures, degradations of card stock quality, and the presence of any imperfections. In one embodiment, properties of the collectible card include the availability of a particular collectible card, and flaws to the collectible card. In some embodiments, a third-party grading system may certify and authenticate a card and provide grading to the card according to specifications of the third-party grading system.

The grading card may include security or authenticity features such as holograms or security ink. In some embodiments, the grading card may include a quick response (QR) code, bar code, RFID tag, or NFC chip may be integrated into the grading card or the upper window portion 745. A user may interact with the QR code, bar code, RFID tag, or NFC chip using a mobile device with a software application installed thereon. The user may bring the mobile computing device, such as a smartphone, in proximity to the grading card, an address, or a webpage may be provided to the user's smartphone. The address or webpage may contain information regarding the card and/or grade or rating associated with the card. In some embodiments, the information may include digital images or video of the card showing different aspects of the card, close-up images of any imperfections may be imaged or highlighted. In various embodiments, the information may include a write-up by the person who graded the card with insight or opinion on the grading. The webpage or card information may include links or information describing the grading process, what was taken into account for the particular card protected by the protective apparatus, aspects of the card that positively or negatively impacted grading, and the like. In some embodiments, the webpage or card information includes sufficient information that the card can be consistently graded given the methodology and the facts that are provided.

Cross-section A-A and B-B are also depicted in FIG. 7A, with lines A-A and B-B indicating the location of the cross-section.

In the illustrated embodiment of FIG. 7B, measurements of various aspects of the card protector are shown, such as the length of 90 mm and width of 64.5 mm of the lower window portion. It can be appreciated that the measurements of the card protector may be different.

FIG. 7C depicts measurements of a logo 760 in some embodiments. In some embodiments, the logo 760 includes two words, “Rare” and “EDITION.” In one embodiment, the word “Rare” may have a width of 6.5 mm and a height of 3.18 mm, while “EDITION” may have a width of 6.1 mm and a height of 0.96 mm. In one embodiment, the logo 760 may be embossed or stamped into the supporting member 734 of the back panel 700. In some embodiments, other methods may be used to transfer the logo onto the supporting member 734. In one example, the logo 760 may be gold in color, the color of the logo 760 may be hot stamped. In some embodiments, other printing methods may be used to give the logo color.

FIG. 8A depicts a front panel 800 and cross-sections of the card protector in some embodiments. In the illustrated embodiment of FIG. 8A, measurements of various aspects of the card protector are shown, such as a length of 133.94 mm and a width of 83.44 mm of the front panel 800.

The front panel 800 includes a body 810 with an elevated ledge 820. The body 810 may be a horizontal sheet of polycarbonate in a rectangular shape and may have rounded or sharp corners. The front panel 800 may have the same shape as the back panel 700. The front panel 800 may be composed of polycarbonate or polystyrene. In some embodiments, the body 810 may have a height of 2.85 mm, a length of 133.94 mm, and a width of 83.44 mm. In the illustrated embodiment of FIG. 8A and 5A, the front panel 800 is physically larger than the back panel 700. Furthermore, the front panel 800 may include two cavities, one on a front side and one on the back side. During the fabrication of the protective apparatus, the back panel 700 may be placed inside a cavity 830 on the back side of the front panel 800. In some embodiments, the cavity 830 may have a length of 131.21 mm, a width of 80.71 mm, and a height of 5.50 mm. A scratch-resistant glass, such as CORNING® GORILLA® glass, may be applied to a cavity 835 on the front side of the front panel 800. The cavity 835 may be fabricated or located on a surface of the front panel 800 that is opposite from the cavity 830. In some embodiments, the cavity 835 may have a height of 1.15 mm. The front panel 800 further includes an area 840. The area 840 may be a protrusion of the body 810. In some embodiments, this protrusion may be utilized as an energy director for ultrasonic welding. Further details regarding the protrusion seen in the area 840 will be discussed in FIG. 8B.

The area 840 from FIG. 8B is an energy director for ultrasonic welding in some embodiments. In the illustrated embodiment, the area 840 is a triangular protrusion from the body 810. The triangular protrusion may have a base of 0.70 mm and a height of 0.61 mm. It can be appreciated that the measurements of the card protector may be different. The energy director focuses the ultrasonic energy at an apex of the energy director, causing the material which makes up the triangular protrusion to melt and flow, thereby forming a weld.

FIG. 9 depicts a cross-section of a back panel 910 and a front panel 920 of protective apparatus 900 in some embodiments. After the back panel 910 and the front panel 920 have been fabricated, the two panels may be assembled to fabricate the card protective apparatus. In some embodiments, the back panel 910 and the front panel 920 may be adhered together using ultrasonic welding. As seen in FIGS. 7B and 8A, the back panel 910 includes a surface area that is smaller than a cavity of the front panel 920 such that the back panel 910 may be contained within the cavity of the front panel 920. By retaining the back panel 910 within the confines of front panel 920, the protective apparatus 900 may become more tamper-proof, making it more difficult to separate the back panel 910 from the front panel 920.

In various embodiments, a grading card system and marketplace may allow for grading and trading of collectible objects protected by the protective apparatus 100. The protective apparatus 100 may include link information (e.g., URL), unique code (e.g., passcode, barcode, or QR code), and the like that identifies the collectible and/or links to the grading system and/or the marketplace for the collectible object.

In some embodiments, the unique code may include an encryption code or other security code such that, using the protective apparatus 100 (or information contained within), the user may access a secure, online location to update information about the collectible object. For example, the user may scan a QR code on the protective apparatus 100 using their smartphone or an app which navigates a browser or the app to a secure location of the grading system or the marketplace system. The secure location may allow the user to update information about the collectible object, including ownership information, contact information, information about the quality of the collectible object, and/or the like. The changes of the information of the collectible object may be displayed within the grading system or the marketplace.

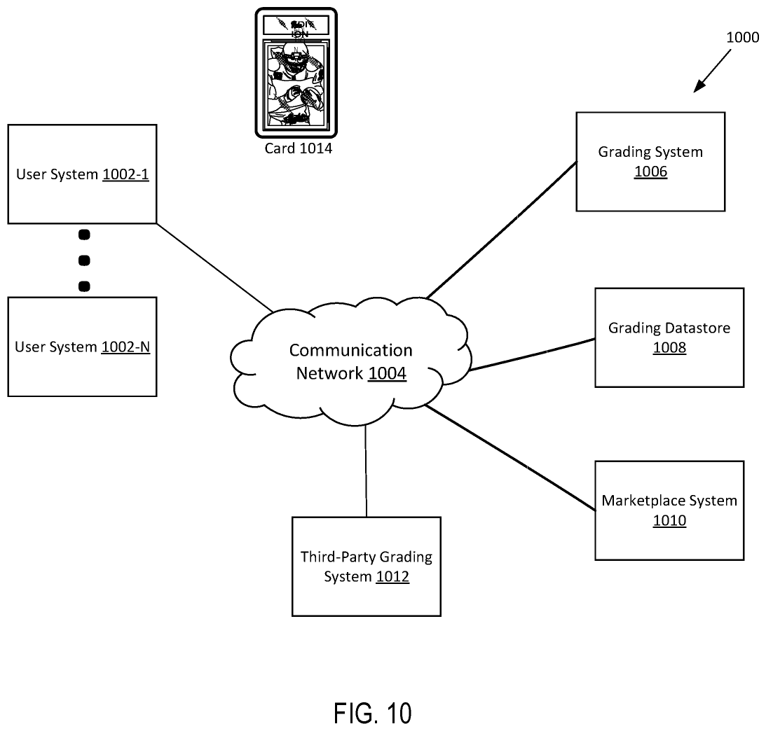

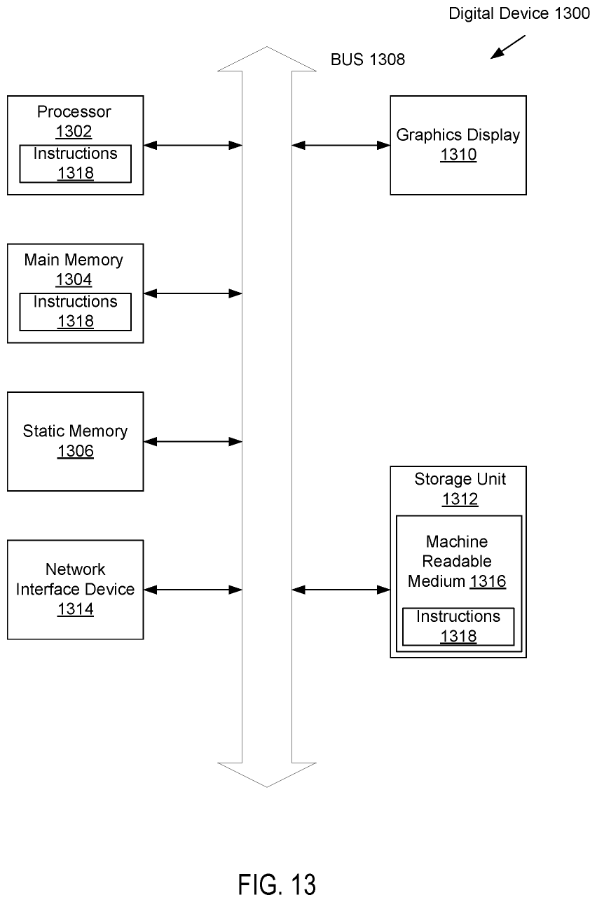

FIG. 10 depicts a block diagram of an example environment 1000 capable of grading collectible objects and/or providing grading records associated with the collectible objects in some embodiments. The example environment 1000 includes user systems 1002-1 to 1002-N (individually, user system 1002 collectively), a communication network 1004, a grading system 1006, a grading datastore 1008, a marketplace system 1010, and a third-party grading system 1012. The user systems 1002-1 to 1002-N, the grading system 1006, the marketplace system 1010, and the third-party grading system 1012 may each be or include any number of digital devices. Digital devices are further discussed herein (e.g., see FIG. 13).

The grading system 1006 and/or the third-party grading system 1012 may provide grades or indications of quality of the collectible object. The marketplace system 1010 may allow for users to buy or sell collectible objects (e.g., protected by the protective apparatus 100) online.

In some embodiments, user system 1002-1 may be configured to facilitate communication between users and other associated systems. In some embodiments, the user system 1002-1 may be or include one or more mobile devices (e.g., smartphones, cell phones, smartwatches, table computer, or the like), desktop computers, laptop computers, and/or the like. In some embodiments, the user system 1002-1 may include an image capture device which allows a user of the user system 1002-1 to capture digital images or digital video of a collectible card 1014. The user system 1002-1 may upload the digital images or digital video of the collectible card 1014 to the grading system 1006 for grading. In various embodiments, the user system 1002-1 may upload the digital images or digital video of the collectible card 1014 to the marketplace system 1010 or the third-party grading system 1012.

In some embodiments, communication network 1004 represents one or more computer networks (e.g., LANs, WANs, and/or the like). The communication network 1004 may provide communication between any of user system 1002, the grading system 1006, the grading datastore 10081010//, and the third-party grading system 1012. In some implementations, the communication network 1004 comprises computer devices, routers, cables, uses, and/or other network topologies. In some embodiments, the communication network 1004 may be wired and/or wireless. In various embodiments, the communication network 1004 may comprise the Internet, one or more networks that may be public, private, IP-based, non-IP based, and so forth.

In some embodiments, users may interact with user system 1002 using, for example, a web browser or mobile application to communicate with other users, access web pages on the grading system 1006, marketplace system 1010, or the third-party grading system 1012.

In some embodiments, the grading system 1006 may utilize machine-learning algorithms to categorize a collectible object based on digital images or digital video received by the grading system 1006. For example, a user may take an image of both sides of a collectible card and provide the images to the grading system 1006. The grading system 1006 may then analyze the images using the machine-learning algorithms.

Alternately, in some embodiments, the user may send or have the collectible card sent to the grading system 1006 (e.g., through secure delivery). The collectible card may be inspected and scanned (e.g., using high-quality scanners, cameras, or mobile devices). The grading system 1006 may then analyze the images using the machine-learning algorithms. Once graded, the collectible card may be secured within the protective apparatus 100. The grade and grading system may be identified on the protective apparatus 100 (e.g., through information that is contained within the protective apparatus 100 but is viewable through the upper window or otherwise detectable by the security features). The collectible card and the protective apparatus 100 may then be returned to the user.

In some embodiments, the grading system 1006 using a consistent, duplicable grading methodology that allows for consistent grades and consistent evaluation. For example, the grading system 1006 may utilize a completely computational approach (e.g., using machine optical evaluation) to evaluate the collectible card. The grading methodology may be labeled or named such that when the grading methodology changes, there is a new label or name for the grading methodology. The label or name for the grading methodology used to grade a collectible card may be identified on the protective apparatus 100 (e.g., through information that is contained within the protective apparatus 100 but is viewable through the upper window or otherwise detectable by the security features). This allows for consistency, repeatability, and dependability of the grading which may impact the value of the collectible card.

Grading of a collectible card may be based on properties of the card such as centering of images on the card, sharpness of the corners of the card, gloss on the card, fading of pictures, degradations of card stock quality, and the presence of any imperfections. The grading card may include a score or category of the collectible card based on the properties of the collectible card. The grading card may be placed in an upper window portion of the collectible card 1014, while the collectible card is placed in a lower window portion of the collectible card 1014.

In various embodiments, the grading system 1006 may receive images of the collectible card. The grading system 1006 may apply image segment analysis to identify pixels and/or sets of pixels within the images and then make comparisons against trained featured for comparison of quality of colors, saturation of colors, sharpness of corners, gloss, indications of card stock quality, marks, and/or any imperfections. The result of the image segment analysis may be a set of features that are scored for an overall grade.

It may be appreciated that by using a completely computational approach and avoiding manual evaluation (even manual expert evaluation), the grading is consistent and reproduceable.

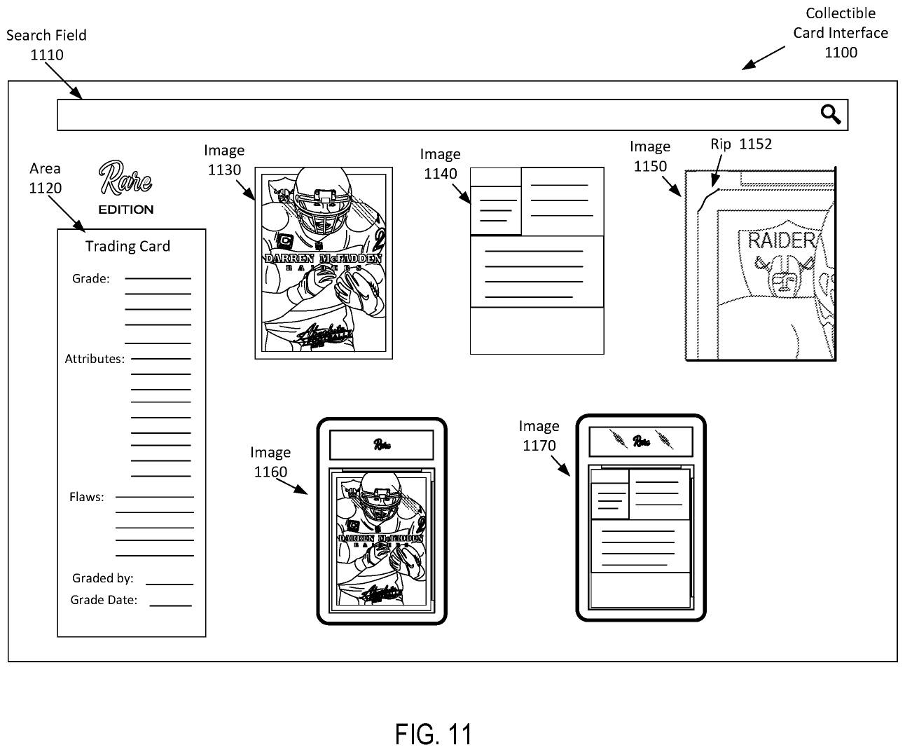

In some embodiments, the grading system 1006 may provide a collectible card interface, such as a collectible card interface 1100 of FIG. 11. Further details regarding the collectible card interface will be discussed in FIG. 11.

In one example, the owner of the collectible card may send the physical collectible card to a card grading system, the card grading system, such as the grading system 1006 or the third-party grading system 1012, may capture digital images or digital video of the collectible card for purposes of grading the collectible card. The digital images may include close-up or zoomed-in digital images of areas of the collectible card, such as one or more corners of the card, a central area of the collectible card depicting an athlete, or any imperfections which may appear on the collectible card.

Digital media of graded or ungraded collectible cards may be stored in the grading datastore 1008. The grading datastore 1008 may be any structure and/or structures suitable for storing data entries or records (e.g., an active database, a relational database, a self-referential database, a table, a matrix, an array, a flat file, a documented-oriented storage system, a non-relational No-SQL system, an FTS-management system such as Lucene/Solar, and/or the like). The grading datastore 1008 may include collectible card entries, which includes information such as the grading of the collectible card, properties of the collectible card, a date of when the collectible card was received by the grading system 1006, a date of when the collectible card was graded, a user account associated with the person who submitted the collectible card to the grading system 1006. In various embodiments, collectible card entries may store the profile of users who submitted the collectible card for grading. In some embodiments, collectible card entries include categorical identifiers such as sports cards and non-sports cards. Sports cards may include collectible cards depicting images of athletes who are members of various professional and amateur sports teams. Non-sports cards may include collectible card games such as POKEMON or MAGIC THE GATHERING.

In one embodiment, the marketplace system 1010 provides an online platform to connect users to buy or sell graded or ungraded collectible cards. The marketplace system 1010 may utilizes images stored in the grading datastore 1008 and/or indications of evaluation, quality, and grading from the grading system 1006 (and/or the third-party grading system 1012). In various embodiments, by using the grading system 1006 and the marketplace system 1010, the history of ownership, quality of the card, and history of the card may be tracked. The marketplace system 1010 may provide the history of ownership, quality of the card, and history of the card as a historical provenance regarding the particular collectible thereby improving tracking, reducing counterfeits, reducing opportunities for tampering, providing contact information for any entity that may have altered the collectible, and the like. This information improves the certainty of quality of the collectible and improves the overall value of the collectible for later sale or purchase.

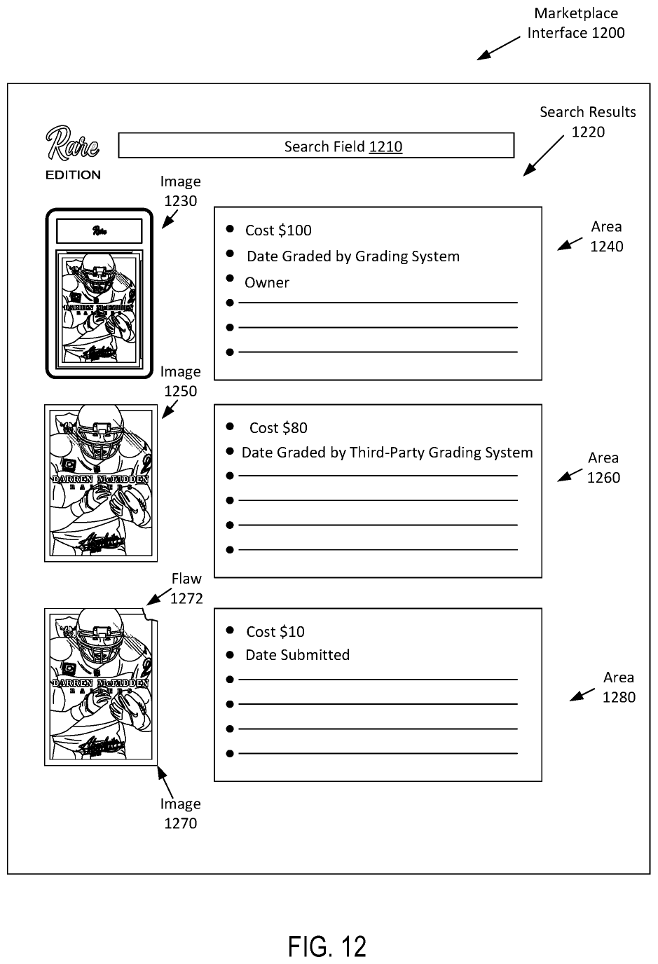

In one example, the marketplace system 1010 may provide a user interface, such as the marketplace interface 1200 of FIG. 12. Further details regarding the marketplace interface will be discussed in FIG. 12.

FIG. 11 depicts a collectible card interface 1100 containing information regarding a card in some embodiments. The collectible card interface 1100 includes a search field 1110, an area 1120, and images 1130 through 1170.

A user navigating a user interface of the grading system 1006 may be provided the user interface. The result of the search may be the collectible card interface 1100. Search criteria may include graded or ungraded cards, a categorical identifier may include sports cards or non-sports cards, type of sports, name of the sports team, type of collectible card game, a collectible card ranking. The grading system 1006 may receive one or more search criteria and perform a search on the collectible card entries of the grading datastore 1008. The output of the search may be a list of search results that includes one or more collectible card entries which at least one of the provided search criteria. The user may interact with one of the collectible cards in the list of search results. The grading system 1006 may send a request to the grading datastore 1008 for a particular collectible card entry. The grading datastore 1008 may provide information regarding the particular collectible card. The particular collectible card entry may be a graded or ungraded collectible card. In some embodiments, the collectible card entry includes digital media associated with the particular collectible card entry captured by the grading system 1006. The digital media may be provided to the collectible card interface 1100.

The area 1120 of the collectible card interface 1100 may include some information regarding the particular collectible card. Information may include the grade of the particular collectible card provided by the grading system 1006. In some embodiments, the area 1120 may include a grade or rating provided by a different grading system such as the third-party grading system 1012. In one example, the area 1120 may include properties of the particular collectible card such as attributes and flaws of the collectible card such as the sharpness of the corners of the collectible card, bends or breaks in the card, centering of images on the card gloss on the card, fading of pictures, degradations of card stock quality, and the presence of any imperfections or flaws.

The collectible card interface 1100 may include digital images of the particular collectible card. For example, the image 1130 depicts a view of the front of the particular collectible card, without the protective apparatus. The image 1130 includes a picture of a particular a certain person, such as an athlete, along with their name, the name of a professional or amateur sports team the athlete belongs to. The image 1140 depicts a view of the back of the particular collectible card. In some embodiments, the image 1140 includes a short description of the athlete, a description of the picture on the front view of the collectible card, statistics, or trivia.

The image 1150 may depicts a zoomed-in or close-up of a top left corner of the collectible card. The collectible card interface 1100 may include images of a small area of the collectible with flaws or imperfections. For example, the top left corner of the collectible card includes a rip 1152. In some embodiments, the collectible card interface 1100 may include images of aspects or properties of the collectible card which support the grade or ranking given to the card. For example, if the collectible card has very sharp corners or the picture on the front of the collectible card is centered, the collectible card interface 1100 may include images that depict a close-up of these parts of the collectible card.

The collectible card interface 1100 may further include images 1150 and 1160, which depict a front and back view of the collectible card placed within a protective apparatus such as the protective apparatus 500 of FIG. 5A.

FIG. 12 depicts a marketplace interface 1200 in some embodiments. The marketplace interface 1200 includes a search field 1210 and search results 1220.

A user may input one or more search criteria to the search field 1210. The search criteria may include graded or ungraded card, categorical identifier may include sports cards or non-sports cards, type of sports, name of the sports team, type of collectible card game, a collectible card ranking. The grading system 1006 may receive the one or more search criteria and perform a search on the collectible card entries of the grading datastore 1008. The output of the search may be a list of the search results 1220, which includes one or more collectible cards entries which at least one of the provided search criteria. Each collectible card entry may include digital images of a particular collectible card, along with data regarding the particular collectible card including the cost of the card, if the card has been graded, a name of the grading system which graded the card, owner of the card.

For example, an image 1230 of a first collectible card, information regarding the first collectible card can be found in area 1240. The area 1240 may include data such as a price for the card, a name of the grading system which graded the card, and a name of the owner of the card. Additional information may include properties of the first collectible card such as attributes or flaws.

The marketplace interface 1200 may include images 1250 and 1270 of a second and a third collectible card respectively. Information regarding the second and the third collectible card can be found in areas 1260 and 1280. In the illustrated example of FIG. 11, the cost of the third collectible card may be lower compared the first and second collectible cards because of a flaw 1272 or rip of the third collectible card. The user may zoom in or magnify a portion of each of the images 1230, 1250, and 1270. In some embodiments, the areas 1240, 1260, and 1280 each may include an uniform resource locator (URL) which may allow a user to purchase the collectible card.

FIG. 13 is a block diagram illustrating entities of an example digital device able to read instructions from a machine-readable medium and execute those instructions in a processor to provide control functions, provide interfaces, receive commands, and the like as discussed herein. Specifically, FIG. 13 shows a diagrammatic representation of a digital device in the example form of a digital device 1300 within which instructions 1318 (e.g., software) for causing the machine to perform any one or more of the methodologies discussed herein may be executed. In alternative embodiments, the machine operates as a standalone device or may be connected (e.g., networked) to other machines, for instance, via the Internet.

The digital device may include a processor and memory any may include a PIC, processor, raspberry PI, or the like.

The example digital device 1300 includes a processor 1302 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1304, and a static memory 1306, which are configured to communicate with each other via a bus 1308. The digital device 1300 may further include a graphics display unit 1310 (e.g., a plasma display panel (PDP), a liquid crystal display (LCD), a projector, or a cathode ray tube (CRT)). The digital device 1300 may also include a data store 1312 and a network interface device 1314, which also are configured to communicate via the bus 1308.

The data store 1312 includes a machine-readable medium 1316 on which is stored instructions 1318 (e.g., software) embodying any one or more of the methodologies or functions described herein. The instructions 1318 (e.g., software) may also reside, completely or at least partially, within the main memory 1304 or within the processor 1302 (e.g., within a processor's cache memory) during execution thereof by the digital device 1300, the main memory 1304 and the processor 1302 also constituting machine-readable media. The instructions 1318 (e.g., software) may be transmitted or received over a network (not shown) via optional network interface 1314.

While machine-readable medium 1316 is shown in an example embodiment to be a single medium, the term “machine-readable medium” should be taken to include a single medium or multiple media (e.g., a centralized or distributed database, or associated caches and servers) able to store instructions (e.g., instructions 1318). The term “machine-readable medium” shall also be taken to include any medium that is capable of storing instructions (e.g., instructions 1318) for execution by the digital device and that cause the machine to perform any one or more of the methodologies disclosed herein. The term “machine-readable medium” includes, but should not be limited to, data repositories in the form of solid-state memories, optical media, and magnetic media.

Polycarbonate also has a higher impact resistance when compared with polystyrene Also offers greater UV protection and is resistant to temperature changes.

1. A protective apparatus comprising:
a first panel, the first panel including a front side and a back side, the first panel including at least a transparent portion;
a rear panel coupled to the first panel, the rear panel including a front side and a back side, the front side of the rear panel including at least four supporting members, each of the at least four supporting members including a flat edge to enable positioning of a collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object; and
a mask coupled to the back side of the first panel, the mask being opaque and extending around a perimeter of the back side of the first panel, the mask covering an inside of the protective apparatus between the first panel and the second panel.

2. The protective apparatus of claim 1, wherein the first panel and the second panel comprise polycarbonate, the protective apparatus being thereby protected from at least some impacts and UV light.

3. The protective apparatus of claim 1, further comprising a bumper made of a resilient material that surrounds edges of the first panel and the second panel.

4. The protective apparatus of claim 1, further comprising a security feature between the first panel and the second panel, the security feature including at least one of an NFC chip and an RFID chip, the security feature being beneath the mask such that the security feature is not visible from the front of the first panel.

5. The protective apparatus of claim 1, further comprising an elevated edge along the edge of the first panel or the second panel, the elevated edge extending between the first panel and the second panel, the elevated edge preventing debris from entering the protective apparatus.

6. The protective apparatus of claim 1, further comprising an elevated edge along the edge of the first panel or the second panel, the elevated edge extending between the first panel and the second panel, the elevated edge being ultrasonic welded to the first panel or the second panel to prevent tampering with the collectible object.

7. The protective apparatus of claim 6, wherein the ultrasonic welding of the elevated edge prevents water from entering between the first panel and the second panel if the protective apparatus is submerged.

8. The protective apparatus of claim 1, further comprising a protective layer adhered to the front side of the first panel, the protective layer being transparent and configured to prevent damage to the front side of the first panel.

9. The protective apparatus of claim 2, further comprising an identifier that is hot stamped on the polycarbonate.

10. The protective apparatus of claim 1, the mask defining a first window and a second window of the first panel, the second window being rectangular and over at least a portion of the cavity to enable viewing of the collectible object, the first window being rectangular and shorter than the first window.

11. The protective apparatus of claim 5, wherein the rear panel or the front panel includes a perimeter member at the perimeter of the rear panel or the front panel, the perimeter member configured to engage with the elevated edge to couple the first panel and the second panel together to reduce opportunities for tampering with the collectible object.

12. The protective apparatus of claim 11, the elevated edge being ultrasonic welded to the perimeter member.

13. A method for fabricating a protective apparatus, the method comprising:
fabricating a first panel, the first panel including a front side and a back side, the first panel including at least a transparent portion;
fabricating a rear panel, the rear panel including a front side and a back side, the front side of the rear panel including at least four supporting members, each of the at least four supporting members including a flat edge to enable positioning of a collectible object, the flat edge of a first two of the supporting members being parallel to each other, the flat edge of a second two of the supporting members being parallel to each other and perpendicular to the first two of the supporting members, a cavity being at least between the flat edges of the four supporting members, the cavity capable of holding the collectible object;
coupling a mask to the back side of the first panel, the mask being opaque and extending around a perimeter of the back side of the first panel, the mask covering an inside of the protective apparatus between the first panel and the second panel; and
coupling the first panel and the second panel.

14. The method of claim 13, wherein the first panel and the second panel are made of polycarbonate, the protective apparatus being thereby protected from at least some impacts and UV light.

15. The method of claim 13, further comprising coupling a bumper made of a resilient material around edges of the first panel and the second panel.

16. The method of claim 13, further comprising adding a security feature between the first panel and the second panel before the first panel is coupled to the second panel, the security feature including at least one of an NFC chip and an RFID chip, the security feature being beneath the mask such that the security feature is not visible from the front of the first panel.

17. The method of claim 13, the first panel or the second panel further comprising an elevated edge along the edge of the first panel or the second panel, the elevated edge extending between the first panel and the second panel, the elevated edge preventing debris from entering the protective apparatus.

18. The method of claim 13, wherein coupling the first panel and the second panel comprises ultrasonic welding an elevated edge to couple the first panel and the second panel, the elevated edge being along the edge of the first panel or the second panel, the elevated edge extending between the first panel and the second panel, the elevated edge preventing debris from entering the protective apparatus.

19. The method of claim 18, wherein the ultrasonic welding of the elevated edge prevents water from entering between the first panel and the second panel if the protective apparatus is submerged.

20. The method of claim 13, further comprising coupling a protective layer to the front side of the first panel, the protective layer being transparent and configured to prevent damage to the front side of the first panel.
